(19) United States
(12) Patent Application Publication
(10) Pub. No.: US 2021/0390455 A1
(43) Pub. Date: Dec. 16, 2021

(54) SYSTEMS AND METHODS FOR MANAGING MACHINE LEARNING MODELS

(71) Applicant: DataRobot, Inc., Boston, MA (US)

(72) Inventors: Amanda Schierz, Hampshire (GB); Drew Roselli, Woodinville, WA (US); Dulcardo Arteaga, Sunnyvale, CA (US); Christopher Cozzi, Denver, CO (US); Samuel Clark, Boston, MA (US); John Bledsoe, Columbus, OH (US); Mykola Novik, Chernihivs'ka Oblast (UA); Amar Mudrankit, San Jose, CA (US); Lior Amar, Sunnyvale, CA (US); Evan Chang, Sunnyvale, CA (US); Scott Oglesby, Cupertino, CA (US); Tristan Robert Spaulding, Arlington, MA (US)

(21) Appl. No.: 17/344,252

(22) Filed: Jun. 10, 2021

Related U.S. Application Data
(60) Provisional application No. 63/037,894, filed on Jun. 11, 2020.

(51) Int. Cl. G06N 20/00; G06N 5/04

(52) U.S. Cl. CPC G06N 20/00; G06N 5/04

(57) ABSTRACT

The subject matter of this disclosure relates to systems and methods for monitoring and managing machine learning models and related data. Histogram structures can be used to aggregate streams of numerical data for storage and metric calculations. Drift in such data can be identified and monitored over time. When significant drift is detected and/or when model accuracy has deteriorated, models can be automatically refreshed with updated training data and/or replaced with one or more other models. A model controller is used to automate model monitoring and management activities across multiple prediction environments where models are deployed and prediction jobs are executed.

### CROSS-REFERENCE TO RELATED APPLICATIONS

This application claims priority to and benefit of U.S. Provisional Application No. 63/037,894, titled “Systems and Methods for Managing Machine Learning Models” and filed under Attorney Docket No. DRB-016PR on Jun. 11, 2020, the entire disclosure of which is hereby incorporated by reference.

### TECHNICAL FIELD

The present disclosure generally relates to systems and methods for monitoring and managing machine learning models and related data. Some examples described herein relate specifically to systems and methods for processing streams of data, identifying and monitoring drift in data over time, and taking corrective action in response to data drift and/or model inaccuracies.

### BACKGROUND

Machine learning is being integrated into a wide range of use cases and industries. Unlike certain other applications, machine learning applications (including deep learning and advanced analytics) can have multiple independent running components that operate cohesively to deliver accurate and relevant results. This complexity can make it difficult to manage or monitor all the interdependent aspects of a machine learning system.

In some instances, for example, data for a machine learning model can be provided in a data stream of unknown size and/or having thousands or millions of numerical values per hour, and lasting for several hours, days, weeks, or longer. Failing to properly store, process, or aggregate such data streams can result in catastrophic failures in which data is lost or models are otherwise unable to make predictions. Additionally, such data can drift over time to be significantly different from data that was used to train the model, which can result in model performance issues.

### SUMMARY

In general, the present disclosure relates to systems and methods for monitoring and managing machine learning models and data used by such models. A stream of data used by the models can be aggregated using histogram structures (e.g., centroid histograms) that approximate traditional histograms and require far less data storage. The histogram structures can avoid catastrophic data processing failures associated with previous or traditional data stream aggregation processes, and can be used to calculate a wide variety of metrics, including, for example, medians and percentiles. Additionally or alternatively, the systems and methods described herein can be used to identify or monitor drift occurring in data and/or model predictions over time. When drift is identified in scoring data used to make model predictions, for example, alerts can be generated to inform users or system components about the drift. Additionally or alternatively, such alerts can be triggered when model inaccuracies are detected or when model predictions deviate from expectations (e.g., due to data drift). In response to the alerts, the systems and methods can be used to take corrective action, for example, by retraining or refreshing a model with updated training data, or by switching to a new model (e.g., a challenger model).

In general, one innovative aspect of the subject matter described in the present disclosure can be embodied in a computer-implemented method of processing a stream of data or building a histogram for the stream of data. The method includes: (a) providing a histogram for a stream of data including numerical values, the histogram including a centroid vector having elements for storing centroid values, and a count vector having elements for storing count values corresponding to the centroid values; (b) receiving a next numerical value for the stream of data; (c) identifying two adjacent elements in the centroid vector having centroid values less than and greater than the next numerical value; (d) inserting a first new element between the two adjacent elements in the centroid vector; (e) inserting a second new element between corresponding adjacent elements in the count vector; (f) storing the next numerical value in the first new element in the centroid vector; (g) setting a count value in the second new element in the count vector to be equal to one; (h) identifying two neighboring elements in the centroid vector having a smallest difference in centroid values; (i) merging the two neighboring elements in the centroid vector into a single element including a weighted average of the centroid values from the two neighboring elements; (j) merging two corresponding neighboring elements in the count vector into a single element including a sum of the count values from the two corresponding neighboring elements; and (k) repeating steps (b) through (j) for additional next numerical values for the stream of data.

In certain examples, providing the histogram can include initializing the histogram, and initializing the histogram can include: providing the centroid vector and the count vector each having an initial length N; receiving a set of N initial numerical values for the stream of data; storing the N initial numerical values in numerical order in the centroid vector; and setting each value in the count vector to be equal to one. Providing the histogram can include initializing the histogram at periodic time intervals. A duration of each periodic time interval can be or include one hour, one day, one week, or one year. The next numerical value can fall between centroid values stored in the adjacent elements of the centroid vector.

In some implementations, identifying the two neighboring elements can include calculating a difference in centroid values between each set of adjacent elements in the centroid vector. Step (k) can include: repeating steps (b) through (j) until a specified time duration is reached; and storing the histogram for later reference. The method can include converting the histogram to a new histogram having a plurality of buckets, each bucket including a lower bound, an upper bound, and a count. The method can include calculating a cumulative count for each of the plurality of buckets. The method can include calculating at least one of a median or a percentile for the new histogram based on the cumulative counts.

In another aspect, the present disclosure relates a system having one or more computer systems programmed to perform operations including: (a) providing a histogram for a stream of data including numerical values, the histogram including a centroid vector having elements for storing centroid values, and a count vector having elements for storing count values corresponding to the centroid values; (b) receiving a next numerical value for the stream of data; (c) identifying two adjacent elements in the centroid vector having centroid values less than and greater than the next numerical value; (d) inserting a first new element between the two adjacent elements in the centroid vector; (e) inserting a second new element between corresponding adjacent elements in the count vector; (f) storing the next numerical value in the first new element in the centroid vector; (g) setting a count value in the second new element in the count vector to be equal to one; (h) identifying two neighboring elements in the centroid vector having a smallest difference in centroid values; (i) merging the two neighboring elements in the centroid vector into a single element including a weighted average of the centroid values from the two neighboring elements; (j) merging two corresponding neighboring elements in the count vector into a single element including a sum of the count values from the two corresponding neighboring elements; and (k) repeating steps (b) through (j) for additional next numerical values for the stream of data.

In certain examples, providing the histogram can include initializing the histogram, and initializing the histogram can include: providing the centroid vector and the count vector each having an initial length N; receiving a set of N initial numerical values for the stream of data; storing the N initial numerical values in numerical order in the centroid vector; and setting each value in the count vector to be equal to one. Providing the histogram can include initializing the histogram at periodic time intervals. A duration of each periodic time interval can be or include one hour, one day, one week, or one year. The next numerical value can fall between centroid values stored in the adjacent elements of the centroid vector.

In some implementations, identifying the two neighboring elements can include calculating a difference in centroid values between each set of adjacent elements in the centroid vector. Step (k) can include: repeating steps (b) through (j) until a specified time duration is reached; and storing the histogram for later reference. The operations can include converting the histogram to a new histogram having a plurality of buckets, each bucket including a lower bound, an upper bound, and a count. The operations can include calculating a cumulative count for each of the plurality of buckets. The operations can include calculating at least one of a median or a percentile for the new histogram based on the cumulative counts.

In another aspect, the present disclosure relates to a non-transitory computer-readable medium having instructions stored thereon that, when executed by one or more computer processors, cause the one or more computer processors to perform operations including: (a) providing a histogram for a stream of data including numerical values, the histogram including a centroid vector having elements for storing centroid values, and a count vector having elements for storing count values corresponding to the centroid values; (b) receiving a next numerical value for the stream of data; (c) identifying two adjacent elements in the centroid vector having centroid values less than and greater than the next numerical value; (d) inserting a first new element between the two adjacent elements in the centroid vector; (e) inserting a second new element between corresponding adjacent elements in the count vector; (f) storing the next numerical value in the first new element in the centroid vector; (g) setting a count value in the second new element in the count vector to be equal to one; (h) identifying two neighboring elements in the centroid vector having a smallest difference in centroid values; (i) merging the two neighboring elements in the centroid vector into a single element including a weighted average of the centroid values from the two neighboring elements; (j) merging two corresponding neighboring elements in the count vector into a single element including a sum of the count values from the two corresponding neighboring elements; and (k) repeating steps (b) through (j) for additional next numerical values for the stream of data.

In another aspect, the present disclosure relates to a computer-implemented method including: providing a machine learning model configured to predict a preferred combination of a binning strategy and a drift metric for determining data drift; determining one or more data characteristics for at least one data set; providing the one or more characteristics as input to the machine learning model; receiving as output from the machine learning model an identification of the preferred combination of the binning strategy and the drift metric for the at least one data set; using the predicted combination to determine drift between a first data set and a second data set; and facilitating a corrective action in response to the determined drift.

In various examples, the first data set can include training data and the second data set can include scoring data. The first data set and the second data set can include data for a single feature of a predictive model. The one or more characteristics can include a length, a distribution, a minimum, a maximum, a mean, a skewness, a number of unique values, or any combination thereof. The at least one data set can include the first data set, the second data set, or both the first data set and the second data set. The at least one data set can include numerical data, and the binning strategy can include use of fixed width bins, quantiles, quartiles, deciles, ventiles, Freedman-Diaconis rule, Bayesian Blocks, or any combination thereof. The at least one data set can include categorical data, and the binning strategy can include use of (i) one bin per level in a training data sample plus one, (ii) one bin per level in a portion of the training data sample plus one, (iii) inverse binning, or (iv) any combination thereof.

In certain implementations, the at least one data set includes text data, and the binning strategy includes use of (i) inverse binning, (ii) one bin per quantile based on word use frequency, or (iii) any combination thereof. The drift metric can include use of population stability index, Kullback-Leibler divergence, relative entropy, Hellinger distance, Isolation Forest (e.g., ratio of training anomalies to scoring anomalies), modality drift, Kolmogorov-Smirnov test, Wasserstein distance, or any combination thereof. Facilitating the corrective action can include retraining a predictive model, switching to a new predictive model, collecting new data for the first data set, collecting new data for the second data set, or any combination thereof. The method can include: determining a percentage of anomalies in the first data set; determining a percentage of anomalies in the second data set; and calculating an anomaly drift based on the percentage of anomalies in the first data set and the percentage of anomalies in the second data set.

In another aspect, the present disclosure relates to a system having one or more computer systems programmed to perform operations including: providing a machine learning model configured to predict a preferred combination of a binning strategy and a drift metric for determining data drift; determining one or more data characteristics for at least one data set; providing the one or more characteristics as input to the machine learning model; receiving as output from the machine learning model an identification of the preferred combination of the binning strategy and the drift metric for the at least one data set; using the predicted combination to determine drift between a first data set and a second data set; and facilitating a corrective action in response to the determined drift.

In various examples, the first data set can include training data and the second data set can include scoring data. The first data set and the second data set can include data for a single feature of a predictive model. The one or more characteristics can include a length, a distribution, a minimum, a maximum, a mean, a skewness, a number of unique values, or any combination thereof. The at least one data set can include the first data set, the second data set, or both the first data set and the second data set. The at least one data set can include numerical data, and the binning strategy can include use of fixed width bins, quantiles, quartiles, deciles, ventiles, Freedman-Diaconis rule, Bayesian Blocks, or any combination thereof. The at least one data set can include categorical data, and the binning strategy can include use of (i) one bin per level in a training data sample plus one, (ii) one bin per level in a portion of the training data sample plus one, (iii) inverse binning, or (iv) any combination thereof.

In certain implementations, the at least one data set includes text data, and the binning strategy includes use of (i) inverse binning, (ii) one bin per quantile based on word use frequency, or (iii) any combination thereof. The drift metric can include use of population stability index, Kullback-Leibler divergence, relative entropy, Hellinger distance, modality drift, Kolmogorov-Smirnov test, Wasserstein distance, or any combination thereof. Facilitating the corrective action can include retraining a predictive model, switching to a new predictive model, collecting new data for the first data set, collecting new data for the second data set, or any combination thereof. The operations can include: determining a percentage of anomalies in the first data set; determining a percentage of anomalies in the second data set; and calculating an anomaly drift based on the percentage of anomalies in the first data set and the percentage of anomalies in the second data set.

In another aspect, the present disclosure relates to a non-transitory computer-readable medium having instructions stored thereon that, when executed by one or more computer processors, cause the one or more computer processors to perform operations including: providing a machine learning model configured to predict a preferred combination of a binning strategy and a drift metric for determining data drift; determining one or more data characteristics for at least one data set; providing the one or more characteristics as input to the machine learning model; receiving as output from the machine learning model an identification of the preferred combination of the binning strategy and the drift metric for the at least one data set; using the predicted combination to determine drift between a first data set and a second data set; and facilitating a corrective action in response to the determined drift.

In another aspect, the present disclosure relates to a computer-implemented method including: obtaining training data including a plurality of features for a machine learning model; obtaining multiple sets of scoring data including the plurality of features for the machine learning model, each set of scoring data representing a respective period of time; for each feature from the plurality of features and for each set of scoring data, providing the training data and the scoring data as input to a classifier; determining, based on output from the classifier, that the sets of scoring data have drifted from the training data over time for at least one of the features; determining that the drift corresponds to a reduction in accuracy of the machine learning model; and facilitating a corrective action to improve the accuracy of the machine learning model.

In certain implementations, the machine learning model can be trained using the training data, and the machine learning model can be used to make predictions based on the scoring data. Each set of scoring data can represent a distinct period of time. The classifier can be or include a covariate shift classifier configured to detect statistically significant differences between two sets of data. Determining that the sets of scoring data have drifted from the training data can include detecting drift over multiple periods of time for the at least one of the features. Determining that the drift corresponds to a reduction in accuracy of the machine learning model can include identifying one or more features from the plurality of features that contributed to the reduction in accuracy.

In some instances, identifying the one or more features can include determining an impact that the one or more features had on the reduction in accuracy. Determining the impact can include displaying on a graphical user interface a chart including an indication of the impact that the one or more features had on the reduction in accuracy. The method can include: using the machine learning model to make predictions for each set of scoring data; and detecting anomalies in the predictions over time. Detecting anomalies in the predictions can include displaying on a graphical user interface a chart including an indication of a quantity of detected anomalies over time. The corrective action can include: sending an alert to a user of the machine learning model, refreshing the machine learning model, retraining the machine learning model, switching to a new machine learning model, or any combination thereof.

In another aspect, the present disclosure relates to a system having one or more computer systems programmed to perform operations including: obtaining training data including a plurality of features for a machine learning model; obtaining multiple sets of scoring data including the plurality of features for the machine learning model, each set of scoring data representing a respective period of time; for each feature from the plurality of features and for each set of scoring data, providing the training data and the scoring data as input to a classifier; determining, based on output from the classifier, that the sets of scoring data have drifted from the training data over time for at least one of the features; determining that the drift corresponds to a reduction in accuracy of the machine learning model; and facilitating a corrective action to improve the accuracy of the machine learning model.

In certain implementations, the machine learning model can be trained using the training data, and the machine learning model can be used to make predictions based on the scoring data. Each set of scoring data can represent a distinct period of time. The classifier can be or include a covariate shift classifier configured to detect statistically significant differences between two sets of data. Determining that the sets of scoring data have drifted from the training data can include detecting drift over multiple periods of time for the at least one of the features. Determining that the drift corresponds to a reduction in accuracy of the machine learning model can include identifying one or more features from the plurality of features that contributed to the reduction in accuracy.

In some instances, identifying the one or more features can include determining an impact that the one or more features had on the reduction in accuracy. Determining the impact can include displaying on a graphical user interface a chart including an indication of the impact that the one or more features had on the reduction in accuracy. The operations can include: using the machine learning model to make predictions for each set of scoring data; and detecting anomalies in the predictions over time. Detecting anomalies in the predictions can include displaying on a graphical user interface a chart including an indication of a quantity of detected anomalies over time. The corrective action can include: sending an alert to a user of the machine learning model, refreshing the machine learning model, retraining the machine learning model, switching to a new machine

In another aspect, the present disclosure relates to a non-transitory computer-readable medium having instructions stored thereon that, when executed by one or more computer processors, cause the one or more computer processors to perform operations including: obtaining training data including a plurality of features for a machine learning model; obtaining multiple sets of scoring data including the plurality of features for the machine learning model, each set of scoring data representing a respective period of time; for each feature from the plurality of features and for each set of scoring data, providing the training data and the scoring data as input to a classifier; determining, based on output from the classifier, that the sets of scoring data have drifted from the training data over time for at least one of the features; determining that the drift corresponds to a reduction in accuracy of the machine learning model; and facilitating a corrective action to improve the accuracy of the machine learning model.

In another aspect, the present disclosure relates to a computer-implemented method including: monitoring a performance of a machine learning model over time; detecting a degradation in the performance of the machine learning model; in response to the detected degradation in the performance, automatically triggering at least one of: switching from the machine learning model to a challenger machine learning model, or updating the machine learning model with new training data; and using at least one of the challenger machine learning model or the updated machine learning model to make predictions.

In certain examples, monitoring the performance of the machine learning model can include comparing model predictions with ground truth data over time. Monitoring the performance of the machine learning model can include detecting a drift in scoring data used to make model predictions. Monitoring a performance of the machine learning model can include displaying on a graphical user interface a chart including an indication of an accuracy of the machine learning model and an accuracy of the challenger machine learning model over time. The degradation can include a reduction in agreement between model predictions and ground truth data. The automatic triggering can be based on one or more characteristics including a size of a data set, a number of rows in the data set, a number of columns in the data set, a historical performance of the challenger machine learning model, a detected drift associated with the challenger machine learning model, a quantity of scoring data that can be matched up with ground truth data, or any combination thereof. The data set can include training data, scoring data, or a combination thereof.

In various instances, switching from the machine learning model to the challenger machine learning model can include selecting the challenger machine learning model from a plurality of challenger machine learning models based on a historical performance of the challenger machine learning model. Updating the machine learning model with new training data can include generating an updated set of training data by combining the new training data with previous training data, reducing an amount of previous training data to accommodate the new training data, replacing previous training data with the new training data, or any combination thereof. Updating the machine learning model with new training data can include reducing an amount of previous training data to accommodate the new training data, and reducing the amount of previous data can include removing a random portion of the previous training data, removing an outdated portion of the previous training data, removing an anomalous portion of the previous training data, or any combination thereof.

In another aspect, the present disclosure relates to a system having one or more computer systems programmed to perform operations including: monitoring a performance of a machine learning model over time; detecting a degradation in the performance of the machine learning model; in response to the detected degradation in the performance, automatically triggering at least one of: switching from the machine learning model to a challenger machine learning model, or updating the machine learning model with new training data; and using at least one of the challenger machine learning model or the updated machine learning model to make predictions.

In certain examples, monitoring the performance of the machine learning model can include comparing model predictions with ground truth data over time. Monitoring the performance of the machine learning model can include detecting a drift in scoring data used to make model predictions. Monitoring a performance of the machine learning model can include displaying on a graphical user interface a chart including an indication of an accuracy of the machine learning model and an accuracy of the challenger machine learning model over time. The degradation can include a reduction in agreement between model predictions and ground truth data. The automatic triggering can be based on one or more characteristics including a size of a data set, a number of rows in the data set, a number of columns in the data set, a historical performance of the challenger machine learning model, a detected drift associated with the challenger machine learning model, a quantity of scoring data that can be matched up with ground truth data, or any combination thereof. The data set can include training data, scoring data, or a combination thereof.

In various instances, switching from the machine learning model to the challenger machine learning model can include selecting the challenger machine learning model from a plurality of challenger machine learning models based on a historical performance of the challenger machine learning model. Updating the machine learning model with new training data can include generating an updated set of training data by combining the new training data with previous training data, reducing an amount of previous training data to accommodate the new training data, replacing previous training data with the new training data, or any combination thereof. Updating the machine learning model with new training data can include reducing an amount of previous training data to accommodate the new training data, and reducing the amount of previous data can include removing a random portion of the previous training data, removing an outdated portion of the previous training data, removing an anomalous portion of the previous training data, or any combination thereof.

In another aspect, the present disclosure relates to a non-transitory computer-readable medium having instructions stored thereon that, when executed by one or more computer processors, cause the one or more computer processors to perform operations including: monitoring a performance of a machine learning model over time; detecting a degradation in the performance of the machine learning model; in response to the detected degradation in the performance, automatically triggering at least one of: switching from the machine learning model to a challenger machine learning model, or updating the machine learning model with new training data; and using at least one of the challenger machine learning model or the updated machine learning model to make predictions.

In another aspect, the present disclosure relates to a computer-implemented method. The method includes: receiving model data from a plurality of prediction environments for a plurality of machine learning models deployed in the prediction environments, the model data including model predictions; providing the model data to a machine learning operations (MLOps) component configured to perform operations including at least one of: aggregating a stream of scoring data, identifying drift in scoring data or model predictions, generating alerts related to the drift, or generating requests related to model adjustment or replacement; receiving, from the MLOps component, a request to take an action for a machine learning model from the plurality of machine learning models, wherein the machine learning model is deployed in a respective prediction environment from the plurality of prediction environments; and implementing the action for the machine learning model in the respective prediction environment.

In certain examples, the model data can include scoring data. Receiving the model data can include aggregating the model data prior to providing the model data to the MLOps component. Each of the prediction environments can include a computing environment in which machine learning models are deployed for making predictions. Each of the prediction environments can include a web-based computing platform hosted by a third party. The MLOps component can include a data aggregation module for aggregating the stream of scoring data, a drift identification module for identifying the drift in scoring data or model predictions, a drift monitoring module for generating the alerts related to the drift, and/or a model management module for generating the requests related to model adjustment or replacement.

In some instances, the action can include refreshing the machine learning model and/or replacing the machine learning model with a different model. Implementing the action can include: selecting a plugin from a plurality of plugins associated with the plurality of prediction environments, wherein the selected plugin is associated with the respective prediction environment; and using the selected plugin to implement the action in the respective prediction environment. The method can include: retrieving a new model from a storage location; and using the selected plugin to deploy the new model in the respective prediction environment. Retrieving the new model from the storage location can include selecting a second plugin associated with the storage location, wherein the second plugin is selected from a plurality of plugins associated with a respective plurality of storage locations.

In another aspect, the present disclosure relates to a system. The system includes one or more computer systems programmed to perform operations comprising: receiving model data from a plurality of prediction environments for a plurality of machine learning models deployed in the prediction environments, the model data including model predictions; providing the model data to a machine learning operations (MLOps) component configured to perform operations including at least one of: aggregating a stream of scoring data, identifying drift in scoring data or model predictions, generating alerts related to the drift, or generating requests related to model adjustment or replacement; receiving, from the MLOps component, a request to take an action for a machine learning model from the plurality of machine learning models, wherein the machine learning model is deployed in a respective prediction environment from the plurality of prediction environments; and implementing the action for the machine learning model in the respective prediction environment.

In certain examples, the model data can include scoring data. Receiving the model data can include aggregating the model data prior to providing the model data to the MLOps component. Each of the prediction environments can include a computing environment in which machine learning models are deployed for making predictions. Each of the prediction environments can include a web-based computing platform hosted by a third party. The MLOps component can include a data aggregation module for aggregating the stream of scoring data, a drift identification module for identifying the drift in scoring data or model predictions, a drift monitoring module for generating the alerts related to the drift, and/or a model management module for generating the requests related to model adjustment or replacement.

In some instances, the action can include refreshing the machine learning model and/or replacing the machine learning model with a different model. Implementing the action can include: selecting a plugin from a plurality of plugins associated with the plurality of prediction environments, wherein the selected plugin is associated with the respective prediction environment; and using the selected plugin to implement the action in the respective prediction environment. The operations can include: retrieving a new model from a storage location; and using the selected plugin to deploy the new model in the respective prediction environment. Retrieving the new model from the storage location can include selecting a second plugin associated with the storage location, wherein the second plugin is selected from a plurality of plugins associated with a respective plurality of storage locations.

In another aspect, the present disclosure relates to non-transitory computer-readable medium having instructions stored thereon that, when executed by one or more computer processors, cause the one or more computer processors to perform operations comprising: receiving model data from a plurality of prediction environments for a plurality of machine learning models deployed in the prediction environments, the model data including model predictions; providing the model data to a machine learning operations (MLOps) component configured to perform operations including at least one of: aggregating a stream of scoring data, identifying drift in scoring data or model predictions, generating alerts related to the drift, or generating requests related to model adjustment or replacement; receiving, from the MLOps component, a request to take an action for a machine learning model from the plurality of machine learning models, wherein the machine learning model is deployed in a respective prediction environment from the plurality of prediction environments; and implementing the action for the machine learning model in the respective prediction environment.

The details of one or more embodiments of the subject matter described in this specification are set forth in the accompanying drawings and the description below. Other features, aspects, and advantages of the subject matter will become apparent from the description, the drawings, and the claims.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic diagram of an example system for managing machine learning models and related data;

FIG. 2 is a screenshot of an example graphical user interface displaying various metrics for a machine learning model;

FIG. 3 is a flowchart of an example method of aggregating data from a data stream;

FIG. 4A is a screenshot of an example graphical user interface displaying a scatter plot of feature drift versus feature importance;

FIG. 4B is a screenshot of an example graphical user interface displaying training and scoring data for a feature;

FIG. 5 is a histogram from an example in which a binning strategy for identifying data drift utilized 10 fixed-width bins;

FIG. 6 is a histogram from an example in which a binning strategy for identifying data drift utilized Freedman-Diaconis bins;

FIG. 7 is a histogram from an example in which a binning strategy for identifying data drift utilized a Bayesian Block method;

FIG. 8 is a histogram from an example in which a binning strategy for identifying data drift utilized ventiles;

FIG. 9 is a histogram from an example in which a binning strategy for identifying data drift utilized deciles;

FIG. 10 is a flowchart of an example method of identifying drift in a set of data;

FIG. 11 is a screenshot of an example graphical user interface displaying a bar chart of feature impact;

FIG. 12A is a screenshot of an example graphical user interface displaying average values and ranges of values for machine learning model predictions;

FIG. 12B includes a table of values for a time series forecasting problem, in accordance with certain examples;

FIG. 12C includes a table of values corresponding to three separate predictions requests for a time series forecasting problem, in accordance with certain examples;

FIG. 12D includes a table of model predictions and actual values for a time series forecasting problem, in accordance with certain examples;

FIG. 13 is a screenshot of an example graphical user interface displaying time histories associated with machine learning model accuracy;

FIG. 14 is a flowchart of an example method of monitoring or managing data drift for a machine learning model;

FIG. 15A is a screenshot of an example graphical user interface displaying time histories for model predictions and accuracy;

FIG. 15B is a screenshot of an example graphical user interface that allows users to create approval policies for predictive models;

FIG. 15C is a screenshot of an example graphical user interface displaying an audit history for deployment of a predictive model;

FIG. 16 is a flowchart of an example method of monitoring and managing a machine learning model;

FIG. 17 is a schematic diagram of a monitoring agent for monitoring features, predictions, and performance of predictive models, in accordance with certain examples;

FIG. 18 is a schematic diagram of a management agent for managing predictive models, in accordance with certain examples;

FIG. 19 is a flowchart of an example method of controlling machine learning operations; and

FIG. 20 is a schematic block diagram of an example computer system for monitoring and managing machine learning models and related data, in accordance with certain embodiments.

### DETAILED DESCRIPTION

“Machine learning” generally refers to the application of certain techniques (e.g., pattern recognition and/or statistical inference techniques) by computer systems to perform specific tasks. Machine learning systems may build predictive models based on sample data (e.g., “training data”) and may validate the models using validation data (e.g., “testing data”). The sample and validation data may be organized as sets of records (e.g., “observations”), with each record indicating values of specified data fields (e.g., “dependent variables,” “outputs,” or “targets”) based on the values of other data fields (e.g., “independent variables,” “inputs,” “features,” or “predictors”). When presented with other data (e.g., “scoring data”) similar to or related to the sample data, the machine learning system may use such a predictive model to accurately predict the unknown values of the targets of the scoring data set.

A feature of a data sample may be a measurable property of an entity (e.g., person, thing, event, activity, etc.) represented by or associated with the data sample. For example, a feature can be the price of an apartment. As a further example, a feature can be a shape extracted from an image of the apartment. In some cases, a feature of a data sample is a description of (or other information regarding) an entity represented by or associated with the data sample. A value of a feature may be a measurement of the corresponding property of an entity or an instance of information regarding an entity. For instance, in the above example in which a feature is the price of an apartment, a value of the feature can be $1,000. As referred to herein, a value of a feature can also refer to a missing value (e.g., no value). For instance, in the above example in which a feature is the price of an apartment, the price of the apartment can be missing.

In various examples, an “entity” (alternatively referred to as a “segment”) can be a specific value for a feature. For example, the feature may be “Customer business area” and values for the feature may include “telecoms,” “electrical,” and the like. The entities in this example include “telecoms” and “electrical.” A segment can be a manually defined cluster that can be picked up by a machine learning algorithm. Clustering can be used to automatically “segment” data, and the resulting segment may or may not match a manual cluster or segment. Cluster and segment can be used interchangeably.

Features can also have data types. For instance, a feature can have an image data type, a numerical data type, a text data type (e.g., a structured text data type or an unstructured (“free”) text data type), a categorical data type, or any other kind of data type. In some cases, the feature values for one or more features corresponding to a set of observations may be organized in a table, in which case those feature(s) may be referred to herein as “tabular features.” Features of the numerical data type and/or categorical data type are often tabular features. In the above example, the feature of a shape from an image of the apartment can be of an image data type. In general, a feature's data type is categorical if the set of values that can be assigned to the feature is finite.

As used herein, “image data” may refer to a sequence of digital images (e.g., video), a set of digital images, a single digital image, and/or one or more portions of any of the foregoing. A digital image may include an organized set of picture elements (“pixels”) stored in a file. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS).

As used herein, “non-image data” may refer to any type of data other than image data, including but not limited to structured textual data, unstructured textual data, categorical data, and/or numerical data.

As used herein, “natural language data” may refer to speech signals representing natural language, text (e.g., unstructured text) representing natural language, and/or data derived therefrom.

As used herein, “speech data” may refer to speech signals (e.g., audio signals) representing speech, text (e.g., unstructured text) representing speech, and/or data derived therefrom.

As used herein, “auditory data” may refer to audio signals representing sound and/or data derived therefrom.

As used herein “time-series data” may refer to data having the attributes of “time-series data.”

As used herein, “time-series data” may refer to data collected at different points in time. For example, in a time-series data set, each data sample may include the values of one or more variables sampled at a particular time. In some embodiments, the times corresponding to the data samples are stored within the data samples (e.g., as variable values) or stored as metadata associated with the data set. In some embodiments, the data samples within a time-series data set are ordered chronologically. In some embodiments, the time intervals between successive data samples in a chronologically-ordered time-series data set are substantially uniform.

Time-series data may be useful for tracking and inferring changes in the data set over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

In certain examples, “seasonality” can refer to variations in time series data that repeat at periodic intervals, such as each week, each month, each quarter, or each year. For example, a time series having a weekly seasonality may exhibit variations that repeat substantially each week, over time.

After a predictive problem is identified, the process of using machine learning to build a predictive model that accurately solves the prediction problem generally includes steps of data collection, data cleaning, feature engineering, model generation, and model deployment. “Automated machine learning” techniques may be used to automate steps of the machine learning process or portions thereof.

As referred to herein, the term “machine learning model” may refer to any suitable model artifact generated by the process of training a machine learning algorithm on a specific training data set. Machine learning models can be used to generate predictions.

As referred to herein, the term “machine learning system” may refer to any environment in which a machine learning model operates. A machine learning system may include various components, pipelines, data sets, other infrastructure, etc.

A machine-learning model can be an unsupervised machine learning model or a supervised machine learning model. Unsupervised and supervised machine learning models differ from one another based on their training datasets and algorithms. Specifically, a training dataset used to train an unsupervised machine learning model generally does not include target values for the individual training samples, while a training dataset used to train a supervised machine learning model generally does include target values for the individual training samples. The value of a target for a training sample may indicate a known classification of the training sample or a known value of an output variable of the training sample. For example, a target for a training sample used to train a supervised computer vision model to detect images containing a cat can be an indication of whether or not the training sample includes an image containing a cat.

Following training, a machine learning model is configured to generate predictions based on a scoring dataset. Targets are generally not known in advance for samples in a test dataset, and therefore a machine learning model generates predictions for the test dataset based on prior training. For example, following training, a computer vision model may be configured to distinguish data samples including images of cats from data samples that do not include images of cats.

As referred to herein, the term “development” with regard to a machine learning model may refer to construction of the machine learning model. Machine learning models may be constructed by computers using training data sets. Thus, “development” of a machine learning model may refer to training of the machine learning model using a training data set. In some cases (generally referred to as “supervised learning”), a training data set used to train a machine learning model can include known outcomes (e.g., labels). In alternative cases (generally referred to as “unsupervised learning”), a training data set does not include known outcomes.

In contrast to development of a machine learning model, as referred to herein, the term “deployment” with regard to a machine learning model may refer to use of a developed machine learning model to generate real-world predictions. A deployed machine learning model may have completed development (e.g., training). A model can be deployed in any system, including the system in which it was developed and/or a third-party system. A deployed machine learning model can make real-world predictions based on a scoring data set. Unlike certain embodiments of a training data set, scoring data set generally does not include known outcomes. Rather, the deployed machine learning model is used to generate predictions of outcomes based on the scoring data set.

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

In general, the subject matter described herein relates to a complete and independent technological solution for machine learning operations (MLOps) that includes a platform-independent environment for the deployment, management, and control of statistical, rule-based, and predictive models. The subject matter includes computer-implemented modules or components for performing data aggregation for data streams, drift identification, drift monitoring, and model management and control. Each computer-implemented module or component can be or include a set of instructions executed by one or more computer processors.

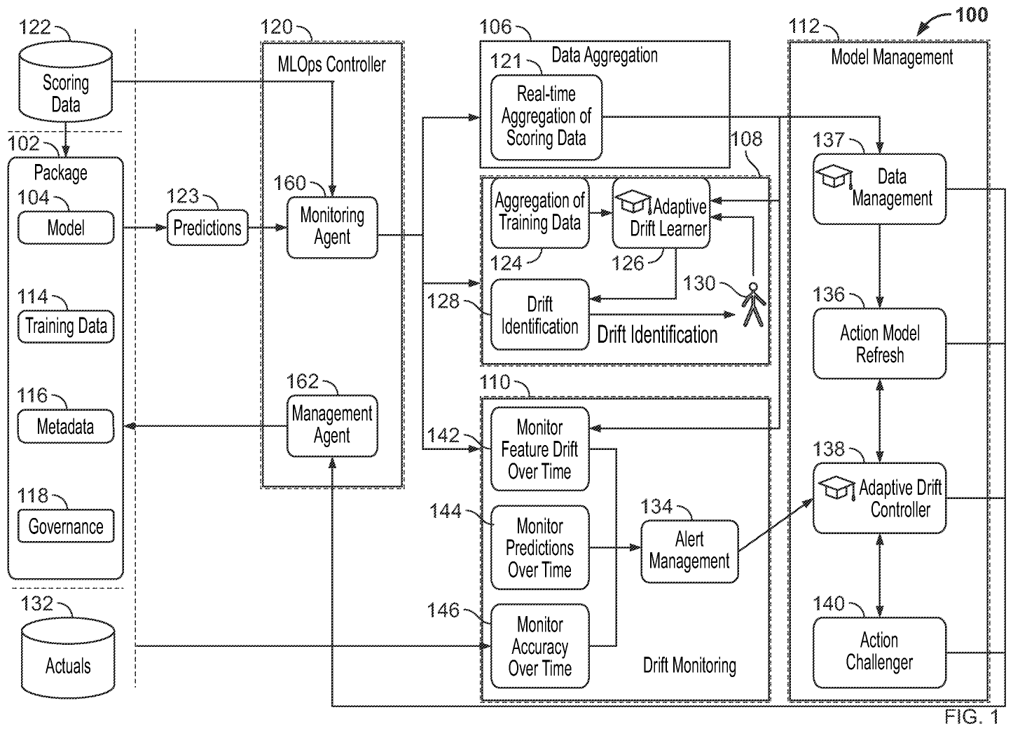

For example, referring to FIG. 1, an example system 100 includes a model package 102 of machine learning models 104 and related data, a data aggregation module 106, a drift identification module 108, a drift monitoring module 110, and a model management module 112. The models 104 may come from different development and machine learning environments, for example, automated machine learning (AutoML) software provided by DATAROBOT or AZURE, or single scripts such as PYTHON NOTEBOOKS. The model package 102 may include training data 114 and any relevant metadata 116, such as important model features or seasonality features. The model package 102 may include a model governance and regulation component 118, which can include or implement certain rules, guidelines, or procedures for use of the models 104.

The model package 102 can be managed and controlled by an MLOps controller 120, which acts as an interface between a prediction environment (e.g., including the model package 102) and an internal or MLOps environment (e.g., including the data aggregation module 106, the drift identification module 108, the drift monitoring module 110, and the model management module 112) for the system 100. The controller 120 can include a monitoring agent 160 and a management agent 162. The monitoring agent 160 can enable monitoring of any model, in any prediction environment, without needing to know a structure of the model, such as model inputs and outputs or a schema for such inputs and outputs. The management agent 162 can enable management of any model in any prediction environment, including initial deployment, model replacement, and execution of prediction jobs.

As described herein, in various examples, the data aggregation module 106 receives a stream of scoring data 122 (e.g., via the controller 120) and aggregates (step 121) the stream of scoring data 122, in real time, to generate a series of histograms (e.g., one histogram per hour) representing the scoring data 122. The histograms can be stored in an aggregated data store and/or can be provided as input to the drift identification module 108, the drift monitoring module 110, the model management module 112, and/or other components of the system 100.

In certain implementations, the drift identification module 108 receives as input (e.g., from the controller 120) the training data 114, the scoring data 122 (or aggregated scoring data 122 from the data aggregation module 106), and/or model predictions 123 and provides as output an indication of (i) a degree to which the scoring data 122 deviates from the training data 114 and/or (ii) a degree to which predictions based on the scoring data 122 (“scoring predictions”) deviate from predictions based on the training data 114 (“training predictions”). The scoring predictions and the training predictions can be included within the model predictions 123, which includes predictions from the model 104. The training data 114 can be aggregated (step 124) and provided to an adaptive drift learner 126, along with the scoring data 122 (e.g., as aggregated by the data aggregation module 106), the training predictions, and/or the scoring predictions. The adaptive drift learner 126 can predict a suitable (e.g., optimal) binning strategy and drift metric to use for one or more features in the training data 114 and/or the scoring data 122. The binning strategy and drift metric can be used to identify drift (step 128) between the training data and the scoring data, and/or between the training predictions and the scoring predictions. A user 130 can accept or reject the determined amounts of drift. Such user feedback can be used to refine the capabilities or accuracy of the adaptive drift learner 126, over time, which can utilize artificial intelligence.

In some examples, the drift monitoring module 110 receives as input (e.g., from the controller 120) the training data 114, the scoring data 122, the model predictions 123 (e.g., including training predictions and/or scoring predictions), and/or ground truth data 132 (alternatively referred to as “actuals”) corresponding to the scoring predictions and generates alerts (e.g., using an alert management component 134) or facilitates other corrective action when feature drift and/or model inaccuracies are detected. Feature drift can be detected using a covariate drift classifier configured to monitor and detect differences between datasets (e.g., the training data and the scoring data), for one or more features. Anomaly detection can be performed and used to flag abnormal model predictions as they occur.

The model management module 112 can be used to refresh models with updated training data and/or to switch between two or more models, for example, in response to alerts received from the drift identification module 108 or the drift monitoring module 110. Refreshing a model (step 136) can involve the use of various data management techniques, for example, to replace old training data with new training data and/or maintain the training data at a reasonable size. Such techniques can be performed by a data management component 137, which can utilize artificial intelligence to determine a suitable (e.g., optimal) data management strategy and/or generate a new or updated set of training data. When model inaccuracies are detected (e.g., by the drift monitoring module 110), an adaptive drift controller 138 can be used to automatically switch (step 140) to a different, challenger model, for example, based on one or more user-defined heuristics, as described herein. Model refreshing and switching can be implemented via the controller 120.

### Aggregation of Scoring Data

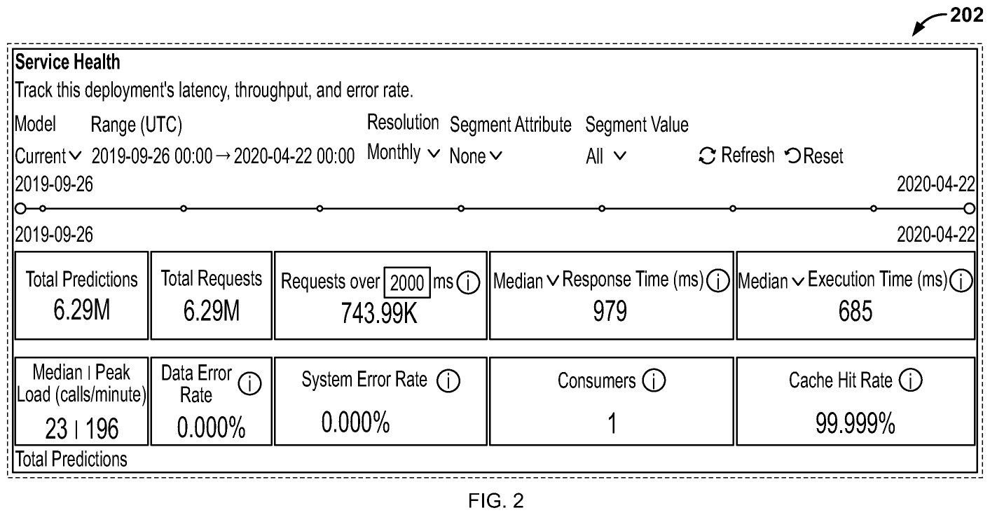

In various examples, the data aggregation module 106 is configured to process a stream of data (e.g., of unknown size or duration) by aggregating (step 121) the data in a collection or series of histograms. The aggregated data can be stored in a data store for subsequent queries and/or can be used to calculate metrics of interest to users of the system 100 (e.g., MLOps service health engineers). Such metrics for a data set can include, for example, minimum, maximum, mean, median, any percentile (e.g., 10th percentile, 90th percentile, quartiles, etc.) and/or counts of values over or under a particular threshold. FIG. 2 includes a screenshot 202 from an example implementation in which users can access or view values for these metrics and/or various model performance statistics. Table 1 presents descriptions of various metrics and/or statistics, which can be selected for different time periods.

TABLE 1
Descriptions of various metrics and/or statistics.

| Statistic | Reports for Selected Time Period |
|---|---|
| Total Predictions | A number of predictions a deployed model has made. |
| Total Requests | A number of prediction requests the deployed model has received |
| Requests over X | A number of requests where a model response time was longer than a |
| milliseconds | specified time period (e.g., number of milliseconds). The default time |
| | period can be 2000 ms and can be user-defined. |
| Response Time | A time (e.g., in milliseconds) the system spent receiving a prediction |
| | request, calculating the request, and returning a response to the user. The |
| | report may not include time due to network latency. The user can select the |
| | median prediction request time or other percentile, such as 90th, 95th, or |
| | 99th percentile. |
| Execution Time | A time (in milliseconds) the system spent calculating a prediction request. |
| | This can be the median prediction request time, 90th, 95th, 99th, or other |
| | percentile. |
| Median/Peak | A median and maximum number of requests per minute. |
| Load | |
| Data Error Rate | A percentage of requests that result in a 4xx error (e.g., problems with a |
| | prediction request submission). |
| System Error | A percentage of well-formed requests that result in a 5xx error (e.g., a server |
| Rate | error) |
| Consumers | A number of distinct users (identified by API token) who have made |
| | prediction requests against the deployed model. |
| Cache Hit Rate | A percentage of requests that used a cached model (the model was recently |
| | used by other predictions). |

Some metrics of interest can be relatively easy to compute without having access to an entire data set or stream. For instance, mean can be computed from sum and count values. Other metrics, such as medians, percentiles, and/or counts over or under thresholds, can be difficult or impossible to compute precisely without accessing or using the entire data set or stream. Advantageously, however, the data aggregation module 106 is able to approximate such metrics through the use of Ben-Ham/Tom-Toy histograms or other histograms (e.g., centroid histograms) that provide an accurate summary or approximation of an entire data set. The data aggregation module 106 is configured to select aggregate values for storage that maximize the number of different metrics that can be computed, while minimizing storage space required for these metrics. In some examples, a Ben-Haim/Tom-Tov (BH-TT) decision tree algorithm can be adapted to efficiently aggregate data from a scoring engine used for machine learning models, at coarse-grained time windows, such as one-hour windows, one-day windows, or one-week windows. In some instances, for example, the data aggregation module 106 utilizes a data structure that is or includes an array of objects, with each object having two properties: centroid and count. The data structure can be used to collect and store data from a stream of data, and the stored data can be used to calculate various metrics (e.g., minimums, maximums, medians, percentiles, and thresholds) related to the data and/or relevant to service health for machine learning models. While the following example utilizes arrays of length 5, it is understood that the array length can larger (e.g., to improve accuracy). For example, the array length can be 5, 10, 15, 20, 50, 100, 200, 500, 1000, or any integer N between or above these values. In one implementation, an array length of 50 works well for most data streams, from an accuracy and computational efficiency standpoint.

A traditional histogram defines how many values are between minimum and maximum bounds for each bin. This can provide a precise and accurate representation of the data, however, all of the data is generally needed to calculate such bounds. A centroid histogram (e.g., a BH-TT histogram), on the other hand, can be an approximation of the traditional histogram. The centroid histogram can define how many values are “near” or “around” each centroid. For example, Table 2 illustrates a centroid histogram having an array length of 5. In this case, there are 16 values near 0.4, 23 values near 1.8, 13 values near 2.2, etc. The centroid histogram can be imprecise because it may not tell you absolute bounds of each bin; rather, it can provide an approximation of a distribution of values. In various examples, the centroid histogram can include a centroid vector containing centroid values, as indicated by the “Centroid” row in Table 2, and a count vector containing count values, as indicated by the “Count” row in Table 2. The centroid vector and/or the count vector can have corresponding offsets or indices, as indicated by the “Offset” row in Table 2.

TABLE 2
Example centroid histogram having a length of 5.

| Offset | 0 | 1 | 2 | 3 | 4 |
|---|---|---|---|---|---|
| Centroid | 0.4 | 1.8 | 2.2 | 3.4 | 4.5 |
| Count | 16 | 23 | 13 | 5 | 8 |

By way of contrast, Table 3 illustrates an example of a corresponding traditional histogram having a length of 5. The traditional histogram is or includes an array of objects, each of which has three properties: minimum boundary, maximum boundary, and count.

TABLE 3
Corresponding traditional histogram having a length of 5.

| Offset | 0 | 1 | 2 | 3 | 4 |
|---|---|---|---|---|---|
| Min. | 0.0 | 1.0 | 2.0 | 3.0 | 4.0 |
| Bound | | | | | |
| Max | 1.0 | 2.0 | 3.0 | 4.0 | 5.0 |
| Bound | | | | | |
| Count | 16 | 23 | 13 | 5 | 8 |

The advantage of choosing an approximation-based histogram, such as the centroid histogram, is that it can be calculated or constructed as “you go along” (e.g., as data is received in a data stream) and can be available to query during the data streaming process. This is advantageous over traditional histograms because, when there is a stream of data of unknown size, the traditional histogram cannot be calculated until the stream has finished, if the stream ever does finish.

In some examples, the centroid histogram can be initiated using an initial set of values from the stream of data. For example, if the initial values in the stream of data are 0.2, 3.5, 1.6, 4.9, 2.3, 4.1, and 0.4, the first five of these values can be added to the histogram as shown in Table 4. In general, the number of initial values added to the histogram during this step is equal to a length of the array (e.g., an initial length N), which is 5 in this case.

TABLE 4
Centroid histogram representing the
first five values from a data stream.

| Offset | 0 | 1 | 2 | 3 | 4 |
|---|---|---|---|---|---|
| Centroid | 0.2 | 1.6 | 2.3 | 3.5 | 4.9 |
| Count | 1 | 1 | 1 | 1 | 1 |

As Table 4 indicates, the initial values can be stored in order by centroid. When a new initial value is added, the stored values can be rearranged, as needed, to keep the values in numerical order.

To add the next value from the stream (2.3 in this case), the value can be added to the array in order, as shown in Table 5. This can be done by, for example: (i) identifying two adjacent elements in the centroid row or vector having centroid values less than and greater than the next value, (ii) inserting a new element between the two adjacent elements in the centroid row, (iii) inserting a new element between corresponding adjacent elements in the count row, (iv) setting a value of the new centroid element (at offset 2) to be equal to the next value (2.3), and (v) setting a value of the new count element to be equal to one. This results in an array length of 6, which exceeds the initial or maximum length of 5, so the next step is to collapse the array back to a length of 5.

TABLE 5
Centroid histogram representing the first
six values from the data stream.

| Offset | 0 | 1 | 2 | 3 | 4 | 5 |
|---|---|---|---|---|---|---|
| Centroid | 0.2 | 1.6 | 2.3 | 3.5 | 4.1 | 4.9 |
| Count | 1 | 1 | 1 | 1 | 1 | 1 |

An example of a method for collapsing the array is as follows. First, the two adjacent or neighboring bins or buckets having closest centroid values are identified and merged proportionally. In this example, the two buckets with the closest centroid values are buckets at offsets 3 and 4. The difference between the centroids in these buckets centroids is 0.6, which is less than the difference between any two other adjacent centroids. These buckets can be proportionally merged by summing the counts for the two buckets and computing a weighted average of the centroids for the two buckets as follows:

$$New Centroid = \frac{( C entroid 1 * C o u n t 1 ) + ( C entroid 2 * C o u n t 2 )}{C o u n t 1 + C o u n t 2} \qquad ( 1 )$$

and

New Count=Count1+Count2 (2)

where Centroid1 and Count1 are the centroid and count values for one of the buckets, and Centroid2 and Count2 are the centroid and count values for the other bucket.

After collapsing, the centroid histogram can be as shown in Table 6. The histogram in this example stores an array with 5 objects but includes or encodes information for six values. Adding more values to the histogram can be done the same way, without increasing the length or size of the array.

TABLE 6
Centroid histogram after proportionally
merging two adjacent buckets.

| Offset | 0 | 1 | 2 | 3 | 4 |
|---|---|---|---|---|---|
| Centroid | 0.2 | 1.6 | 2.3 | 3.8 | 4.9 |
| Count | 1 | 1 | 1 | 2 | 1 |

Advantageously, these centroid histograms can be used to accurately approximate median and percentile values, as well as counts over or under a particular threshold. The techniques for approximating each of these values can similar. An example of computing median, beginning with the centroid histogram from Table 7 (same as Table 2), is as follows.

TABLE 7
Example centroid histogram having a length of 5.

| Offset | 0 | 1 | 2 | 3 | 4 |
|---|---|---|---|---|---|
| Centroid | 0.4 | 1.8 | 2.2 | 3.4 | 4.5 |
| Count | 16 | 23 | 13 | 5 | 8 |

To begin, the total number of values represented by the histogram is calculated. In this case, the histogram encapsulates 16+23+13+5+8=65 total values. Since there are an equal number of values greater than and less than the median, the goal is to approximate the value having 32 larger values and 32 smaller values. The overall minimum and maximum values of the data stream can be stored (e.g., separately, outside of the histogram) over a specific time period. In one implementation, a time period of one hour is used, which means one histogram can be created per hour, for a total of 24 histograms per day. If the data stream includes data for more than one feature, additional histograms can be generated for each time period. For example, if there are 10 features represented by the data stream, 10 histograms can be generated each hour, or one histogram per hour for each feature.

Next, the centroid histogram is converted into a traditional histogram. This can be accomplished by considering that, by definition, half of the values in each bucket of the centroid histogram are greater than the centroid, and the other half of the values are below the centroid. Performing this conversion yields the intermediate structure shown in Table 8.

TABLE 8
Intermediate histogram structure.

| Offset | 0 | 1 | 2 | 3 | 4 |
|---|---|---|---|---|---|
| Centroid | 0.4 | 1.8 | 2.2 | 3.4 | 4.5 |
| Count < | 8 | 11.5 | 6.5 | 2.5 | 4 |
| Centroid | | | | | |
| Count > | 8 | 11.5 | 6.5 | 2.5 | 4 |
| Centroid | | | | | |

Assuming the overall minimum value was 0 and the maximum value was 5 for the time period, the traditional histogram shown in Table 9 can be generated. The count in each interior bin can be computed by summing the count greater than a lower centroid and the count less than an upper centroid. For instance, the count for bin at offset 1 in this example is computed by summing 8 (the count greater than the lower centroid) and 11.5 (the count less than the upper centroid). Counts for bins on the ends of the array can be computed from the minimum value, maximum value, and total count.

TABLE 9
Traditional histogram derived from centroid histogram.

| Offset | 0 | 1 | 2 | 3 | 4 | 5 |
|---|---|---|---|---|---|---|
| Lower | 0 | 0.4 | 1.8 | 2.2 | 3.4 | 4.5 |
| Bound | | | | | | |
| Upper | 0.4 | 1.8 | 2.2 | 3.4 | 4.5 | 5 |
| Bound | | | | | | |
| Count | 8 | 19.5 | 18 | 9 | 6.5 | 4 |

To obtain the median, a cumulative count can be calculated for each bucket, as shown in Table 10. In this example, the median is somewhere between 1.8 and 2.2, because there are 27.5 values less than 1.8 and 45.5 values less than 2.2, and the median is the 33rd value.

TABLE 10
Traditional histogram with cumulative count

| Offset | 0 | 1 | 2 | 3 | 4 | 5 |
|---|---|---|---|---|---|---|
| Lower | 0 | 0.4 | 1.8 | 2.2 | 3.4 | 4.5 |
| Bound | | | | | | |
| Upper | 0.4 | 1.8 | 2.2 | 3.4 | 4.5 | 5 |
| Bound | | | | | | |
| Count | 8 | 19.5 | 18 | 9 | 6.5 | 4 |
| Cumulative | 8 | 27.5 | 45.5 | 54.5 | 61 | 65 |
| Count | | | | | | |

The final step in the computation assumes that the actual values in the bucket are evenly spaced. While this is not precise, it is a good enough approximation when enough buckets are used (e.g., 50 or more). Finding the 33rd value is done by computing:

Median value=LB+(UB−LB)/(CC−PCC)*(MC−PCC) (3)

where LB is lower bound, UB is upper bound, CC is cumulative count, PCC is previous cumulative count, and MC is median count. In this case, the median value, which falls within the bucket at offset 2, is given by: Median value=1.8+(2.2−1.8)/(45.5−27.5)*(33−27.5)=1.92. This final step can include performing a linear interpolation, as shown in Equation (3). Medians and percentiles are one use of these histograms. Counts over or under a particular threshold can also be computed, in a similar manner. In some examples, the histograms, values stored within the buckets of the histograms, and/or metrics calculated using the histograms (e.g., median) can be used by the systems and methods described herein as inputs to one or more machine learning models and/or to calculate or monitor various data characteristics, such as data drift. For example, the histograms, values, and/or metrics can be used by the drift identification module 108 and/or the drift monitoring module 110 to detect data drift, trigger one or more alerts, and/or take other corrective action, as described herein. Additionally or alternatively, the histograms, values, and/or metrics can be used by the model management module 112 to refresh a machine learning model, trigger use of a challenger model, and/or take other corrective action, as described herein.

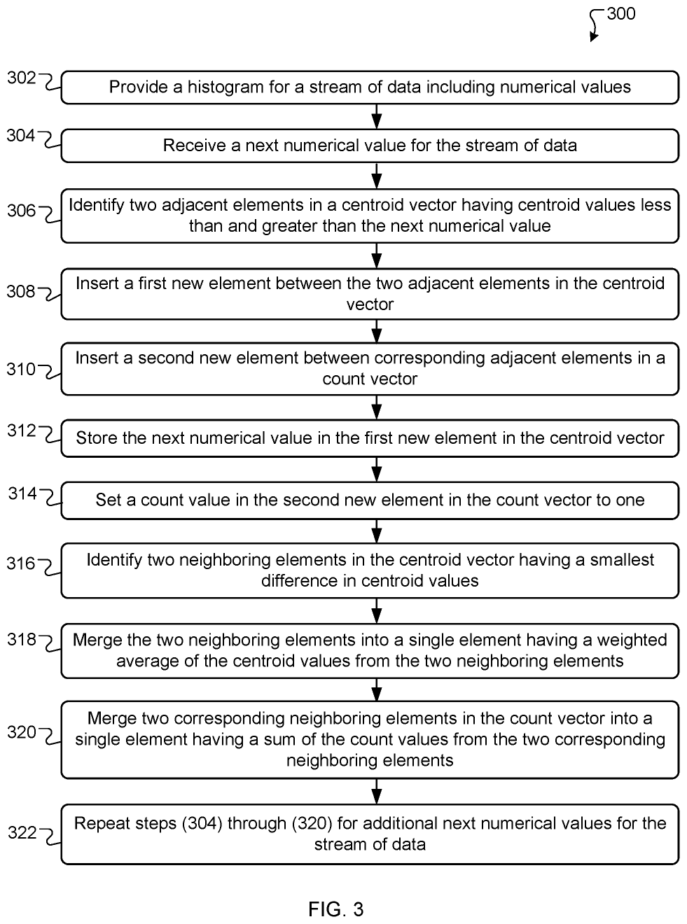

FIG. 3 is a flowchart of a method 300 of aggregating a stream of data. A histogram (e.g., a centroid histogram) is provided (step 302) for a stream of data including numerical values. The histogram includes: a centroid vector having elements for storing centroid values; and a count vector having elements for storing count values corresponding to the centroid values. A next numerical value is received (step 304) for the stream of data. Two adjacent elements in the centroid vector having centroid values less than and greater than the next numerical value are identified (step 306). A first new element is inserted (step 308) between the two adjacent elements in the centroid vector. A second new element is inserted (step 310) between corresponding adjacent elements in the count vector. The next numerical value is stored (step 312) in the first new element in the centroid vector. A count value in the second new element in the count vector is set (step 314) to a value of one. Two neighboring elements in the centroid vector having a smallest difference in centroid values are identified (step 316). The two neighboring elements in the centroid vector are merged (step 318) into a single element, for example, having a weighted average of the centroid values from the two neighboring elements. Two corresponding neighboring elements in the count vector are merged (step 320) into a single element having a sum of the count values from the two corresponding neighboring elements. Steps 304 through 320 are repeated (step 322) for additional next numerical values for the stream of data.

### Drift Identification

Referring again to FIG. 1, in certain implementations, the drift identification module 108 is configured to assess both the scoring data 122 and the scoring predictions for any changes and deviation from the training data 114 and the training predictions (or other model input data or model predictions), over time. Each feature in the data can be assessed individually using the adaptive drift learner 126, which can predict (e.g., using artificial intelligence) a best or preferred binning strategy and drift metric to use for that feature and/or can apply anomaly detection to detect any changes or drift in the data. To make these predictions, the adaptive drift learner 126 can consider various factors related to the feature, such as whether the feature is represented by or includes numeric data, category data, or text data. Additionally or alternatively, the adaptive drift learner 126 can consider: whether numerical values are integers or floating point values; how many levels or categories are included in category data; whether a feature is seasonal and, if so, whether drift is expected; and/or how much data is missing for the feature. The available binning strategies that can be used include, for example, fixed width, fixed frequency, Freedman-Diaconis, Bayesian Blocks, decile, quartile, and/or other quantiles, though other binning strategies are contemplated. Available drift metrics that can be used include, for example, Population Stability Index (PSI), Hellinger distance, Wasserstein distance, Kolmogorov-Smirnov test, Kullback-Leibler Divergence, Histogram intersection, and/other drift metrics, such as user-supplied or custom metrics.

In general, the drift identification module 108 can be used to compare the scoring data 122 and/or the scoring predictions with any other model input data and/or corresponding model predictions, which may or may not be the training data 114 and the training predictions. The scoring data 122 and the scoring predictions can be referred to herein as “compare data” and “compare predictions,” respectively, and the other model input data and the corresponding model predictions can be referred to herein as “reference data” and “reference predictions,” respectively.

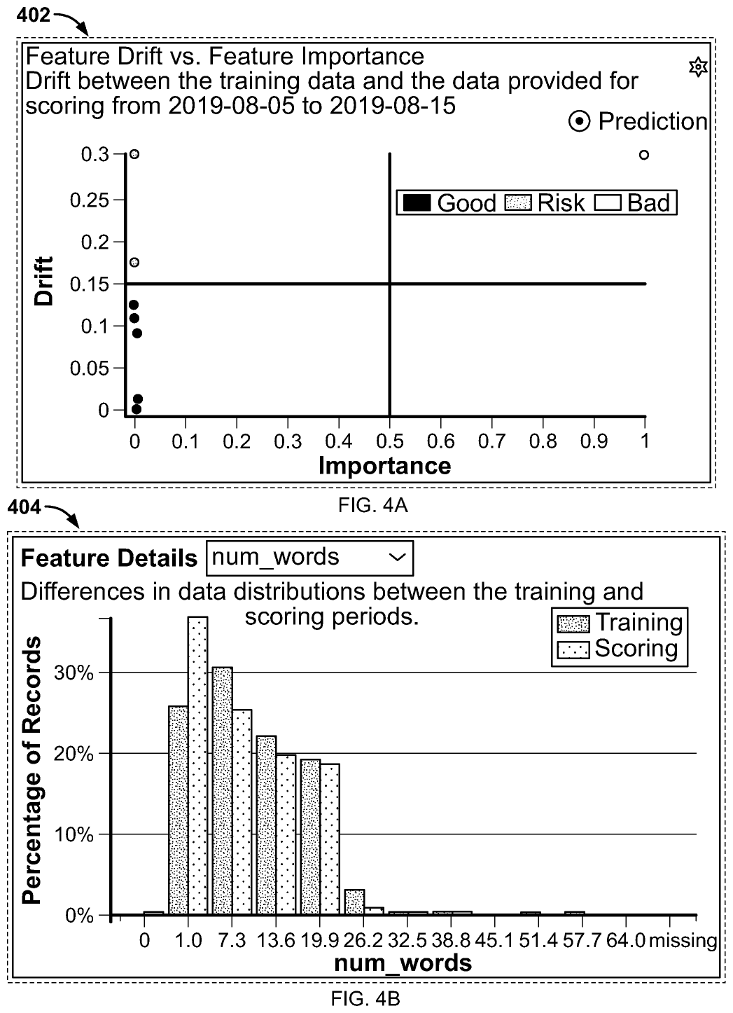

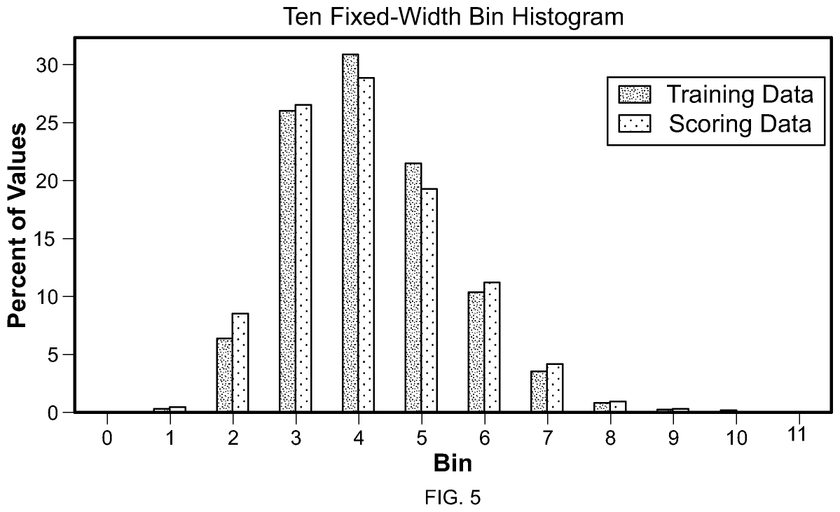

FIGS. 4A and 4B include screenshots showing an example scatter plot 402 and a histogram 404, respectively. The scatter plot 402 represents all the features in a dataset according to drift level and importance, where importance can refer to an impact that a feature has on a model's prediction. In other words, a feature can have a high importance or impact when the model's predictions are highly sensitive to the feature. In some instances, the scatter plot 402 can color code datapoints according to the amount of drift, the importance, or a combination of drift and importance. For example, datapoints having low values can be coded green, datapoints having medium values can be coded yellow, and datapoints having high values can be coded red. The histogram 404 can present training data and scoring data for a single feature. In this case, the histogram 404 shows a percentage of total records for various buckets corresponding to a number of words.

In various implementations, the adaptive drift learner 126 can be a machine learning model created from a series of experiments and a manual assessment of experimental results. A manual set of univariate scenarios can be created to cover different types of drift in numerical, categorical, and/or text features. Tables 11-13 include examples of a few of the experiments created to test bucketing strategies for different two-sample scenarios. Sample 1 in these examples is a feature from training data and Sample 2 is a feature from scoring data. Each scenario is labeled with whether drift should be expected for that test.

TABLE 11
Example numerical data to assess different bucketing strategies and drift
metrics. The table identifies the number of records (e.g., 50000) in each
test and the percentage of missing records (e.g., 1%) in each test.

| Test | | | Expected | Missing |
|---|---|---|---|---|
| ID | Sample 1 | Sample 2 | Drift | Drift |
| 1 | Normal dist., 1% missing | Normal dist., 1% missing | Green | Green |
| | (as NAs). Length 50000. | (as NAs). Length 50000. | | |
| 2 | | Normal dist. 0 missing. | Green | Red (if less |
| | | Length 50000. | | NA is drift) |
| 3 | | Normal dist., 1% missing | Green | Green |
| | | (as NAs). Length 10000. | | |
| 4 | | Normal dist., 5% missing | Green | Red |
| | | (as NAs). Length 50000. | | |
| 5 | | Normal dist., 1% missing | Green | Green |
| | | (as NAs). Length 3000. | | |
| 6 | | Normal dist., 1% missing | Green | Green |
| | | (as NAs). Length 1000. | | |
| 7 | | Sample 1 * 1.5 | Red | Green |

TABLE 12
Example text data to assess different bucketing strategies and drift
metrics. Each test includes product reviews obtained from AMAZON.com.
The table identifies the number of reviews (e.g., 2000) in each test.

| Test | | | Expected |
|---|---|---|---|
| ID | Sample 1 | Sample 2 | Drift |
| 60 | AMAZON Review | AMAZON Review | Green |
| | Summary 2000 short length | Summary 2000 short length | |
| 61 | | AMAZON Review | Green |
| | | Summary 1000 short length | |
| 62 | | AMAZON Review | Green |
| | | Summary 500 short length | |
| 63 | | AMAZON Review | Green |
| | | Summary | |

TABLE 13
Example categorical data to assess different bucketing strategies
and drift metrics. The table identifies the number of records
(e.g., 50000) and category levels (e.g., 3) in each test.

| Test | | | Expected | Missing |
|---|---|---|---|---|
| ID | Sample 1 | Sample 2 | Drift | Drift |
| 32 | 50000 3-level | 50000 3-level | Green | Green |
| 33 | | 10000 3-level | Green | Green |
| 34 | | 1000 3-level | Green | Green |
| 35 | | 50000 4-level | Red | Green |
| 36 | 50000 47-level | 50000 47-level | Green | Green |
| 37 | | 10000 47-level | Green | Green |
| 38 | | 1000 47-level | Green | Green |
| 39 | | 50000 48-level | Red | Green |
| 40 | 10000 3-level | 5000 2-level | Red | Green |

For example, “Expected Drift in these tables indicates whether Sample 1 (from training) and Sample 2 (from scoring) are expected to include or flag drift, with “Green” indicating little or no drift, “Amber” or “Yellow” indicating a moderate amount of drift, and “Red” indicating large amounts of drift. If the PSI metric is used, for example, then default color coding can be as follows: “Green” for less than 0.15; “Amber” or “Yellow” for between 0.15 and 0.25; and “Red” for above 0.25. These default values can be used for prototyping or training experiments. “Missing Drift” in tables 11 and 13 refers to an extra test that was added to indicate whether the scoring data (in Sample 2) includes more missing data, compared to the training data (in Sample 1). Missing data generally refers to data (e.g., for a feature) that is not available (NA) and/or is not usable (e.g., because the data is in an improper format). Features in the scoring data that have a significant amount of missing data when compared to the training data may be indicative of a data quality problem. The adaptive drift learner 126 can be trained to detect or capture this kind of drift or data quality problem, over time.

For each scenario in the manually derived experiments, all binning strategies described herein can be applied, histograms can be created, and each metric can be applied (e.g., for each binning strategy and histogram). Labeling of the most appropriate binning strategy and metric for each drift scenario can be carried out manually. For example, a combination of binning strategy and drift metric can be assigned a label according to how well the combination reveals drift in the data. Combinations that reveal drift accurately can be labelled with a high score (e.g., 10), for example, and combinations that reveal drift inaccurately can be labelled with a low score (e.g., 0 or 1). Output of the tests, including the labels, can be used to create a dataset for predicting the best binning strategy and metric combination, for example, based on the nature or characteristics of the training data feature, such as length, distribution, minimum and maximum, mean, skewness, number of unique values, and other feature characteristics. For example, the adaptive drift learner 126 can be trained using the test output to predict a suitable (e.g., optimal) binning strategy and/or drift metric. Once trained, the adaptive drift learner 126 can receive as input one or more characteristics or features for a set of data (e.g., length, distribution, minimum, maximum, mean, skewness, number of unique values, or any combination thereof) and provide as output a recommended binning strategy and/or drift metric. Table 14 lists a set of example data characteristics for the adaptive drift learner 126. Additional characteristics can be added over time, for example, according to data that a user has optionally supplied (e.g., a use case of the data or a textual description of a data characteristic).

TABLE 14
Example data characteristics.

| Data | | |
|---|---|---|
| Characteristic | Description | Data Type |
| Length of training | Number of values in the training data | Integer |
| Length of scoring | Number of values in the scoring data | Integer |
| Ratio length | Ratio of the length of the training data to the length of | Float |
| | the scoring data | |
| Feature data type | Type of feature - numeric, categorical, text, length, | Categorical |
| | currency, binary | |
| Number of unique | Number of unique values in the training data | Integer |
| values training | | |
| Number of unique | Number of unique values in the scoring data | Integer |
| values scoring | | |
| Training min/max/mean | Three features for the minimum, maximum and mean of | Float |
| | the training data if the feature is numeric. If categorical, | |
| | then frequency counts of each level can be used. If text, | |
| | then word counts can be used. | |
| Scoring min/max/mean | Three features for the minimum, maximum and mean of | Float |
| | the scoring data if the feature is numeric. If categorical, | |
| | then frequency counts of each level can be used. If text, | |
| | then word counts can be used. | |
| Diff min/max/mean | Three features for the differences between the | Float |
| | minimum, maximum and mean of the training data and | |
| | the scoring data. | |
| Number values | Number of unique values training divided by the length | Float |
| length training | of training | |
| Number values | Number of unique values scoring divided by the length | Float |
| length scoring | of scoring | |
| Skewness training | An estimate of how skewed the training data is | Float |
| Distribution | An estimate of the distribution of the training data if | Categorical |
| training | feature is numeric. Blank otherwise. | |
| Target bin metric | Multiclass target of binning strategy plus metric. This | Categorical |
| | target can be derived using “Expected Drift” | |
| | experiments and visually inspecting the resulting | |
| | histograms. | |

With regard to the drift metric, histogram-based metrics such as Population Stability Index (PSI) can be used to assess known populations; however, drift detection can require assessing future or unknown data. When binning the data, PSI can fail if one of the comparison sample bins has a frequency of 0. For purposes of drift detection, when a 0 is encountered in new data, a count of 1 can be added to both the new data bin and the corresponding training bin. This can be done for all histogram-based metrics that may require each bin to have a frequency greater than zero. Example pseudocode for calculating PSI with this zero bin correction technique is provided below.

def calculate_psi(ref_table, com_table, add_one=True):

total_expected = sum(ref_table[ ‘count’ ])
total_actual = sum(com_table[ ‘count’ ])
total_psi = 0
for expected_val, actual_val in zip(ref_table[ ‘count’ ], com_table[ ‘count’ ]):

correction = 0
if add_one:

correction = 1

if expected_val == 0 and actual_val == 0 :

continue

elif (expected_val == 0 or actual_val == 0) and correction == 0:

continue

expected_pct = (expected_val + correction) / float(total_expected + correction)
actual_pct = (actual_val + correction) / float(total_actual + correction)
psi= (actual_pct − expected_pct) * np.log(actual_pct / expected_pct)
total_psi += psi

return total_psi

In various examples, a second adjustment can be made to add a bin for tracking missing data. Missing data (NAs) is typically removed from data before statistical calculations are performed. For drift detection, however, it can be important to track such values as “missing,” which can be indicative of either drift or a data quality problem. In some implementations, the counts of the number of missing values for a feature in the training data and the scoring data can be stored, and an extra bin can be appended to the histogram, regardless of the binning strategy employed. If there is less missing data in the scoring data than in the training data for a feature (e.g., the data is of better quality in the scoring data), then missing drift (e.g., an increased amount of missing data) may not be flagged and may not be included in the overall drift metric (e.g., PSI). In general, when labeling test output, decisions on the “most appropriate” automated binning strategy and drift metric can be based on two main parameters or assessments: (1) is the histogram visually informative?; and (2) did the metric correctly flag drift or incorrectly flag drift?

The adaptive drift learner 126 can use a wide variety of drift metrics. For numeric data, for example, the following metrics can be utilized: Population Stability Index, Kullback-Leibler divergence (relative entropy), Hellinger Distance, Modality Drift (e.g., which can identify bins drifting together), Kolmogorov-Smirnov test, and/or Wasserstein distance. For categorical and/or text data, the following metrics can be utilized: Population Stability Index, Kullback-Leibler divergence, Hellinger Distance, and/or Modality Drift. In general, the drift metric can be used to quantify a similarity or difference between a first distribution of data (e.g., scoring data) and a second distribution of data (e.g., training data). When the drift metric indicates that the two distributions are different, such differences can be indicative of drift.

Additionally or alternatively, the adaptive drift learner 126 can run anomaly detection (e.g., using an isolation forest blueprint or other technique) on the training data to quantify a percentage of anomalies in a training data sample. The anomaly detection model can then be used to predict a percentage of anomalies in a scoring data sample. The adaptive drift learner 126 can generate or output an anomaly drift score, based on a comparison of the percentage or quantity of anomalies in the training data sample and the percentage or quantity of anomalies in the scoring data sample. For example, the anomaly drift score can be the percentage of anomalies in the training data sample divided by the percentage of anomalies in the scoring data sample (e.g., for a specific feature or combination of features).

The adaptive drift learner 126 can also use a wide variety of binning strategies. For numeric data, for example, the following binning strategies can be utilized: 10 fixed-width bins, quantiles (e.g., quartiles, deciles, or ventiles), Freedman-Diaconis, and/or Bayesian Blocks. For categorical data, the binning strategy can be or include, for example, any one or more of the following:
(1) One bin per level in the training data sample (or other reference data sample) plus one bin for “others,” in case the scoring data sample has new levels (e.g., if the training sample has bins of cats, dogs and mice, and the scoring sample also has frogs, then the count of frogs and any other new levels can be added to the “others” bin;
(2) Aggregating by top 50%, 75%, 80%, 90%, or other percentage or frequency in the training (or reference) data sample and having a bin only for the most common levels —in this case, the sum of all other (uncommon) levels can be placed in an “others” bin, and any new levels in the scoring (or compare) data sample can be placed in the “others” bin;
(3) Aggregating by top 50%, 75%, 80%, 90%, or other percentage or frequency in the training data sample, including a bin only for the most common levels, and ignoring new levels in the scoring data sample;
(4) An inverse binning strategy (e.g., for high cardinality situations where flagging fake drift can be a problem, because drift may be flagged as an artefact of a high number of levels) in which quantiles (e.g., deciles) can be calculated from frequency tables, and the number of levels in each quantile can become the count data, such that the y-axis can be the percent of the total number of levels in each quantile bin rather than the percent of the total frequency in each level bin; and/or
(5) A decile binning strategy in which a frequency distribution of the levels in a reference sample (e.g., a training data sample) is used to create a corresponding histogram for a compare sample (e.g., a scoring data sample).
   Binning strategies (3)-(5), above, may be suitable only when cardinality is high. For the inverse binning strategy (4), new levels may be expected and therefore are generally not considered to be drift. Inverse binning may miss drift in certain situations (e.g., when a high frequency level is completely replaced by a new high-frequency level). The decile binning strategy (5) may miss drift when new levels are introduced.

For text data, the binning strategy can involve viewing text as a high-cardinality problem. The addition of new words may not be as important as new levels in categorical data, for example, because the way people write can be subjective, cultural, and/or may have spelling mistakes. For drift in text fields, it is generally more important to identify a shift in the entirety of the language, rather than a shift in individual words. For this reason, binning strategies for high cardinality categoricals can be effective for identifying drift at a whole language level. Such binning strategies can be or include, for example:
(1) An inverse binning strategy in which quantiles (e.g., deciles) can be calculated from frequency tables, and the number of terms (or words) in each quantile can become the count data, such that the y-axis can be the percent of the total number of terms in each quantile bin rather than the percent of the total frequency in each term bin; and/or
(2) A decile binning strategy in which a frequency distribution of the terms in a reference sample (e.g., a training data sample) is used to create a corresponding histogram for a compare sample (e.g., a scoring data sample).
   With the inverse binning strategy (1), the top 10% most frequent words can be put into bin 0 (a first bin), the second most frequent 10% into bin 1, and so on. The same analysis can then be carried out on the scoring data sample using the bins from the training data sample. Inverse binning can miss drift when a high frequency term is completely replaced by a new high-frequency term. Inverse binning may be concerned only with the usage frequency of terms used rather than the frequency of the actual term itself. For example, inverse binning may be useful in high cardinality situations where flagging fake drift can be a problem (e.g., drift may be flagged as an artefact of the high number of levels). Deciles can be calculated from frequency tables and the number of levels in each decile can become the count data. This means the y-axis can be the percent of the total number of levels in each decile bin rather than the percent of the total frequency in each level bin. The decile binning strategy (2) can miss drift when new terms are introduced with low frequency. Prior to binning, text can be vectorized, for example, to convert the text to a vector of terms or token counts (e.g., using Scikit-learn's CountVectorizer).

Alternatively or additionally, the binning strategy for text data can involve giving each frequent word (or phrase) in the training data sample its own bin. The frequency for each bin can be compared directly with the frequency for a corresponding bin for the scoring data sample.

In various examples, the adaptive drift learner 126 can use a revised or adjusted strategy for time series forecasting problems, such as demand forecasting. A distinguishing characteristic of time series forecasting problems is that some drift is inherent and/or expected to occur, for example, due to weekly, monthly, or other seasonal variations in one or more features. Thus, for the adaptive drift learner 126 to identify drift that is unexpected (e.g., due to measurement errors or actual variation), the adaptive drift learner 126 is configured to distinguish between expected drift and unexpected drift. When the unexpected drift becomes large or otherwise unacceptable, the adaptive drift learner 126 can provide warnings indicating that a model is unsuitable for use or may be inaccurate. In various examples, expected drift can be drift that exists in both a training dataset and a scoring dataset. Product offerings, for example, may change over time (e.g., in both the training dataset and the scoring dataset) and such changes may be due to expected drift. On the other hand, when a number of customers decreases for a store in the scoring dataset, but not in the training dataset, the change can be due to unexpected drift and investigation can be carried out to determine the reason(s) for the decrease.

Further, time series forecasting problems can involve segmentation strategies that divide or cluster similar entities (e.g., similar values for a feature or features that exhibit similar variations in time or similar frequency content or seasonality) in the time series into distinct segments (e.g., subgroups) and build models for each segment. The adaptive drift learner 126 and/or model management module 112 can monitor drift on the segments individually and trigger retraining pipelines for each segment. For example, when unexpected drift is large for a segment, the model management module 112 can retrain one or more models associated with the segment. The systems and methods described herein can further explore changes in the segmentation strategies, for example, to contrast finer granularities that may provide more accuracy against coarser granularities that may provide faster predictions or more simplicity. For example, store×SKU (e.g., a product number concatenated to a store identifier) can provide more granularity than just store or SKU individually. Further, new segmentation strategies can be tried, models can be developed for the new segmentation strategies, and the models can be evaluated for performance (e.g., accuracy and/or efficiency). In some examples, recommendations for new segmentation strategies can be sent to users for feedback or approval. Additionally or alternatively, the systems and methods may evaluate alternative means of assigning entities in the time series to segments or clusters, based on signals of drift and performance measured after deployment. For example, features that have similar expected and/or unexpected drift can be combined into a single segment.

Referring again to FIG. 1, the user 130 can complete a feedback loop for the adaptive drift learner 126. Based on the histogram and drift metric presented to the user 130, the user 130 can either accept or reject the decision, with a default being “accept.” In some examples, other combinations of histogram and drift metric can be presented to the user 130, and when the user 130 accepts one of the options, the selection and associated features can be added to a collection of scenarios used in the adaptive drift learner 126 model. A target for this model can be either a one or a zero, indicating whether a given combination of histogram and drift metric is a good or bad strategy, respectively, for a given data set. For example, as described herein, using Freedman-Diaconis as a binning strategy for a training data sample of length 50,000 and a scoring data sample of length 1,000 can be a poor strategy and therefore the associated target in the model can be 0. If the user 130 indicates that the strategy chosen is not appropriate for the user's data samples, then a new row of data (e.g., training data) can be added to the adaptive drift learning 126 model, which can label the strategy as zero for the user's circumstances. When the adaptive drift learner 126 is retrained using the updated data, the adaptive drift learner 126 can learn this new scenario. In this way, the user's feedback (e.g., an acceptance or rejection) can be used to fine-tune or retrain the adaptive drifter learner 126, such that the adaptive drift learner's ability to choose suitable (e.g., optimal) combinations of binning strategy and drift metric can improve, over time.

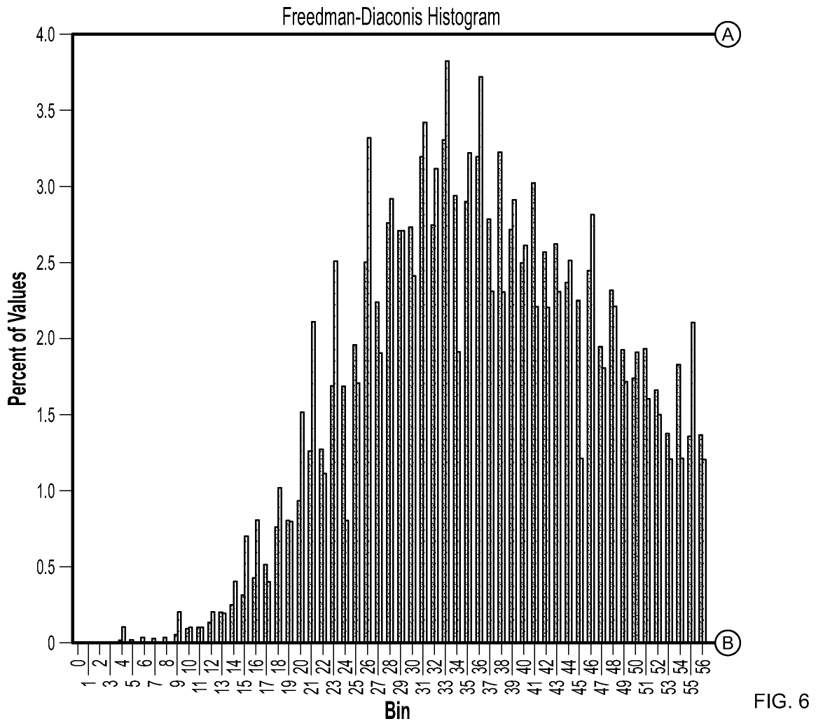

FIGS. 5-9 and Tables 15-19 include results from a set of experiments performed with different binning strategies on test scenario #6, from Table 11. The training data (reference sample) for this test scenario included 50,000 numeric values having 1% missing values and following a normal distribution. The scoring data (compare sample) included 1,000 numeric values having 1% missing values and following a normal distribution. In this case, no data drift was expected because each data set had the same normal distribution. Also, no missing drift was expected because each sample had 1% missing data. The output from these experiments may be used to train the adaptive drift learner 126, as described herein.

The “Minimum Value” column in each of these tables contains the minimum value for each bin or bar on the corresponding histogram, with FIGS. 5, 6, 7, 8, and 9 corresponding to Tables 15, 16, 17, 18, and 19, respectively. For example, in Table 15, the first bin is for values below −2.93, the second bin is for values between −2.93 and −2.14, and so on. The “Percentage of Training Data” and “Percentage of Scoring Data” columns include the percentages of the training data and the scoring data, respectively, that belong to each bin.

FIG. 5 and Table 15 illustrate an example in which the binning strategy utilized 10 fixed-width bins, with under and over bins. This strategy splits the training data sample into 10 equal widths and adds a “below the minimum value” bin and an “over the maximum value” bin, to capture scoring data outliers. The values for the drift metrics in this example were as follows: adjusted PSI=0.02151; Kolmogorov-Smirnov=0.03646; Kullback-Leibler divergence=0.01432; and ratio of anomalies in training to ratio of anomalies in scoring=85.83%. In general, the anomaly score and the Kolmogorov-Smirnov test may be independent of binning and/or may be the same regardless of binning strategy as these metrics may compare the whole of the training data sample to the whole of the scoring data.

TABLE 15
Example histograms for which the binning strategy utilized
10 fixed-width bins, plus over and under bins.

| | | Percentage | Percentage |
|---|---|---|---|
| | Minimum | of Training | of Scoring |
| Bin | Value | Data | Data |
| 0 | −inf | 0 | 0 |
| 1 | −2.93 | 0.31 | 0.4 |
| 2 | −2.14 | 6.31 | 8.54 |
| 3 | −1.34 | 26.02 | 26.53 |
| 4 | −0.54 | 30.9 | 28.84 |
| 5 | 0.26 | 21.46 | 19.3 |
| 6 | 1.06 | 10.38 | 11.16 |
| 7 | 1.86 | 3.54 | 4.12 |
| 8 | 2.66 | 0.86 | 0.9 |
| 9 | 3.45 | 0.18 | 0.2 |
| 10 | 4.25 | 0.03 | 0 |
| 11 | 5.05 | 0 | 0 |

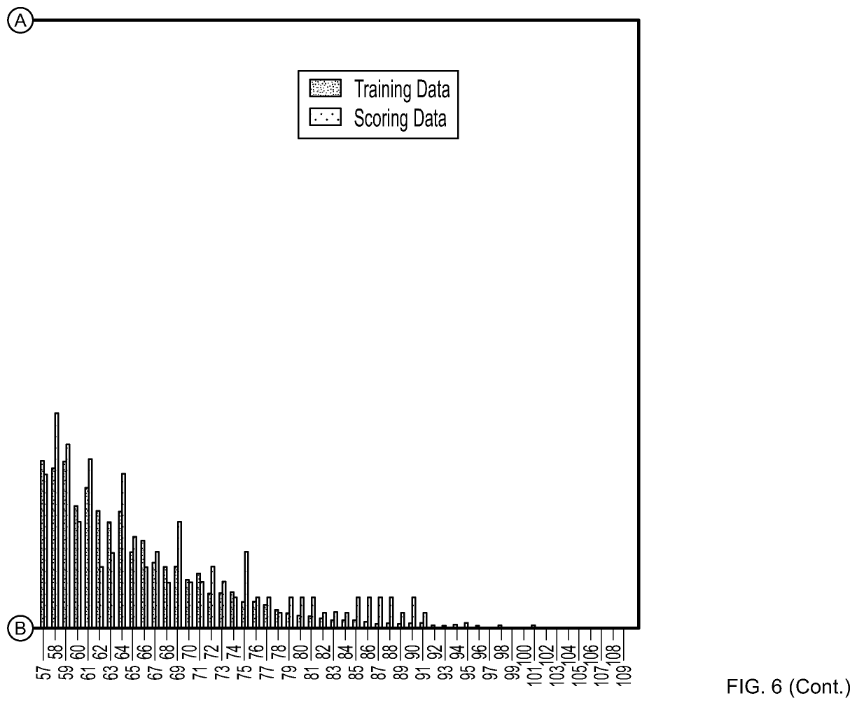

FIG. 6 and Table 16 illustrate an example in which the binning strategy utilized Freedman-Diaconis bins, with under and over bins. This binning strategy can automatically determine bin widths to use based on a distribution of the sample. The values for the drift metrics in this example were as follows: adjusted PSI=0.15951; Kolmogorov-Smirnov=0.03646; and Kullback-Leibler divergence=0.10589. There should be no significant drift in this test scenario; however, because of the high number of low range bins that were created and the difference in sample size between the training data sample (50,000 length) and the scoring data sample (1,000 length), the binning strategy resulted in drift being flagged (e.g., PSI=0.15 and Kullback-Leibler divergence=0.1). As this example illustrates, when the two data samples are considerably different in length, Freedman-Diaconis may not be an appropriate binning strategy to employ, from both a visual perspective and a drift identification perspective.

TABLE 16
Example histograms for which the binning strategy utilized
Freedman-Diaconis bins with under and over bins. This table
includes only a portion of the data presented in FIG. 5.

| | | Percentage | Percentage |
|---|---|---|---|
| | Minimum | of Training | of Scoring |
| Bin | Value | Data | Data |
| 0 | −inf | 0 | 0 |
| 1 | −2.93 | 0 | 0 |
| 2 | −2.86 | 0 | 0 |
| 3 | −2.79 | 0 | 0 |
| 4 | −2.71 | 0.01 | 0.1 |
| . . . | . . . | . . . | . . . |
| 56 | 1.13 | 1.37 | 1.21 |
| 57 | 1.21 | 1.1 | 1.01 |
| 58 | 1.28 | 1.05 | 1.41 |
| 59 | 1.35 | 1.1 | 1.21 |
| 60 | 1.43 | 0.81 | 0.7 |
| 61 | 1.5 | 0.92 | 1.11 |
| 56 | 1.13 | 1.37 | 1.21 |
| . . . | . . . | . . . | . . . |
| 108 | 4.98 | 0 | 0 |
| 109 | 5.05 | 0 | 0 |

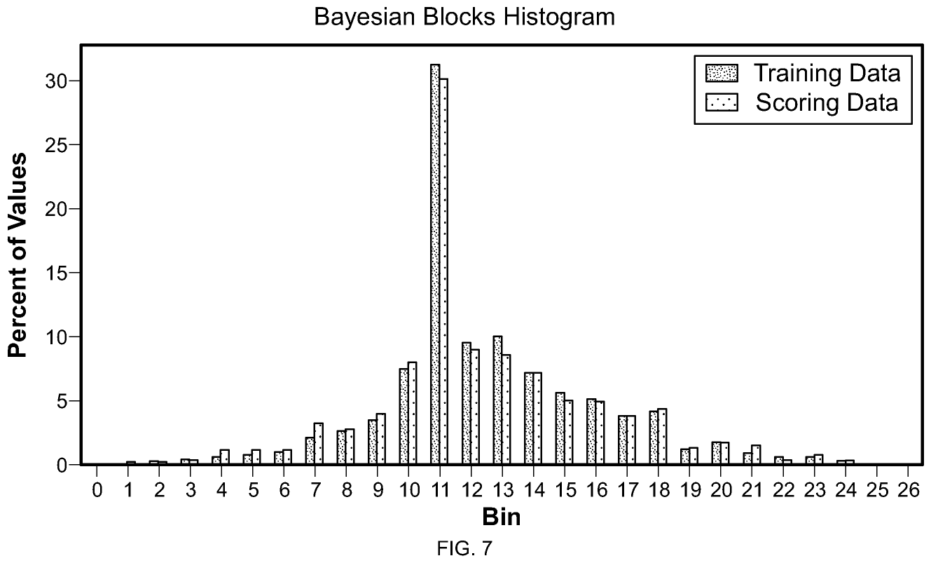

FIG. 7 and Table 17 illustrate an example in which the binning strategy utilized the Bayesian Block method (with over and under bins), which can determine the best bins based on Bayesian probabilities. The values for the drift metrics in this example were as follows: adjusted PSI=0.03587; Kolmogorov-Smirnov=0.03646; and Kullback-Leibler divergence=0.01954. Compared to the Freedman-Diaconis approach, the histogram generated using the Bayesian Block method is more visually informative in this example.

TABLE 17
Example histograms for which the binning strategy utilized
Bayesian Blocks with under and over bins. This table includes
only a portion of the data presented in FIG. 5.

| | | Percentage | Percentage |
|---|---|---|---|
| | Minimum | of Training | of Scoring |
| Bin | Value | Data | Data |
| 0 | −inf | 0 | 0 |
| 1 | −2.93 | 0.02 | 0.1 |
| 2 | −2.57 | 0.12 | 0.1 |
| 3 | −2.28 | 0.4 | 0.3 |
| 4 | −2.01 | 0.51 | 1.11 |
| 5 | −1.86 | 0.71 | 1.11 |
| 6 | −1.73 | 1.03 | 1.11 |
| 7 | −1.61 | 2.12 | 3.22 |
| 8 | −1.44 | 2.63 | 2.71 |
| 9 | −1.29 | 3.53 | 3.92 |
| 10 | −1.14 | 7.49 | 7.94 |
| 11 | −0.9 | 31.21 | 30.05 |
| 12 | −0.12 | 9.42 | 8.84 |
| . . . | . . . | . . . | . . . |
| 24 | 3.34 | 0.21 | 0.2 |
| 25 | 4 | 0.04 | 0 |
| 26 | 5.05 | 0 | 0 |

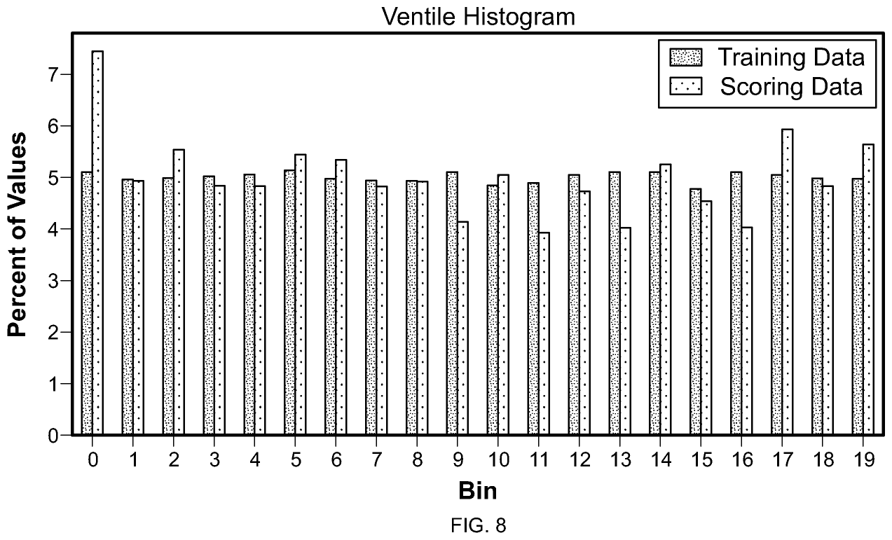

FIG. 8 and Table 18 illustrate an example in which the binning strategy utilized ventiles (with over and under bins), which split the data into 20 equal frequency bins. The values for the drift metrics in this example were as follows: adjusted PSI=0.022; Kolmogorov-Smirnov=0.03646; and Kullback-Leibler divergence=0.01128.

TABLE 18
Example histograms for which the binning strategy
utilized ventiles with under and over bins.

| | | Percentage | Percentage |
|---|---|---|---|
| | Minimum | of Training | of Scoring |
| Bin | Value | Data | Data |
| 0 | −inf | 5.09 | 7.44 |
| 1 | −1.43 | 4.94 | 4.92 |
| 2 | −1.18 | 4.98 | 5.53 |
| 3 | −1.01 | 5 | 4.82 |
| 4 | −0.86 | 5.05 | 4.82 |
| 5 | −0.73 | 5.13 | 5.43 |
| 6 | −0.6 | 4.97 | 5.33 |
| 7 | −0.48 | 4.94 | 4.82 |
| 8 | −0.36 | 4.93 | 4.92 |
| 9 | −0.24 | 5.11 | 4.12 |
| 10 | −0.11 | 4.84 | 5.03 |
| 11 | 0.02 | 4.88 | 3.92 |
| 12 | 0.15 | 5.05 | 4.72 |
| 13 | 0.3 | 5.1 | 4.02 |
| 14 | 0.46 | 5.12 | 5.23 |
| 15 | 0.64 | 4.76 | 4.52 |
| 16 | 0.83 | 5.12 | 4.02 |
| 17 | 1.06 | 5.04 | 5.93 |
| 18 | 1.36 | 4.97 | 4.82 |
| 19 | 1.81 | 4.97 | 5.63 |

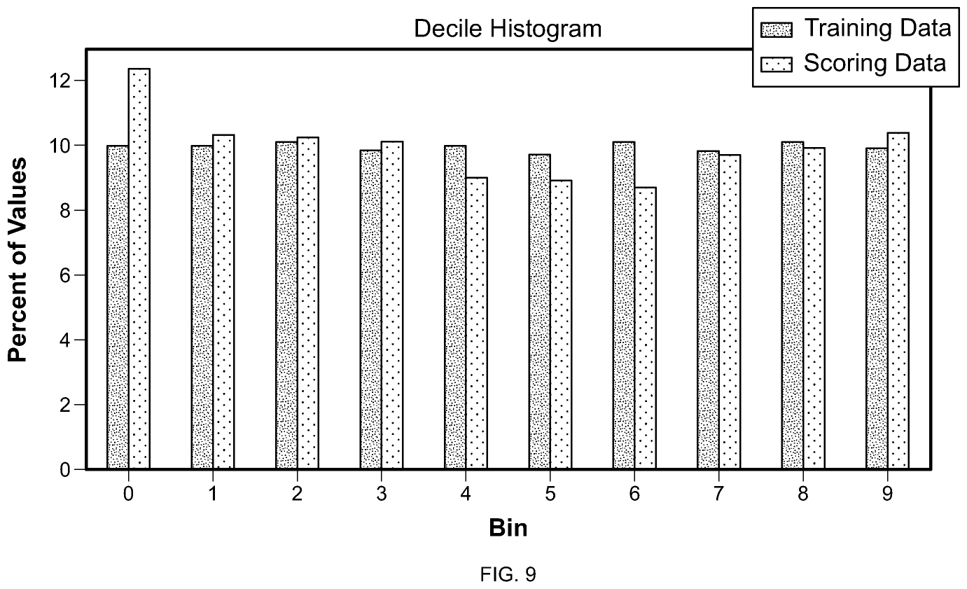

FIG. 9 and Table 19 illustrate an example in which the binning strategy utilized deciles (with over and under bins), which split the data into 10 equal frequency bins. The values for the drift metrics in this example were as follows: adjusted PSI=0.00908; Kolmogorov-Smirnov=0.03646; and Kullback-Leibler divergence=0.00462.

TABLE 19
Example histograms for which the binning strategy
utilized deciles with under and over bins.

| | | Percentage | Percentage |
|---|---|---|---|
| | Minimum | of Training | of Scoring |
| Bin | Value | Data | Data |
| 0 | −inf | 10.03 | 12.36 |
| 1 | −1.18 | 9.99 | 10.35 |
| 2 | −0.86 | 10.18 | 10.25 |
| 3 | −0.6 | 9.91 | 10.15 |
| 4 | −0.36 | 10.04 | 9.05 |
| 5 | −0.11 | 9.72 | 8.94 |
| 6 | 0.15 | 10.15 | 8.74 |
| 7 | 0.46 | 9.87 | 9.75 |
| 8 | 0.83 | 10.16 | 9.95 |
| 9 | 1.36 | 9.95 | 10.45 |

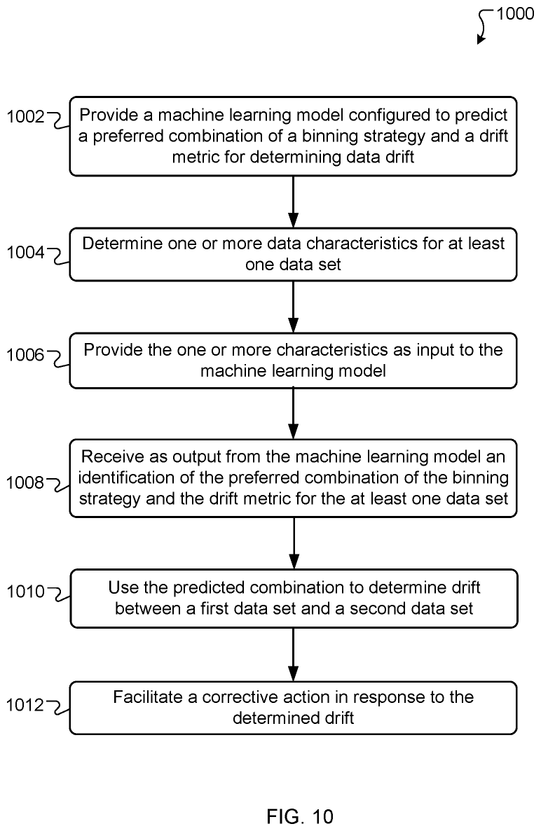

FIG. 10 is a flowchart of a method 1000 of identifying drift in a set of data. A machine learning model is provided (step 1002) that is configured to predict a preferred combination of a binning strategy and a drift metric for determining data drift. One or more data characteristics for at least one data set are determined (step 1004). The one or more characteristics are provided (step 1006) as input to the machine learning model. An identification of the preferred combination of the binning strategy and the drift metric for the at least one data set is received (step 1008) as output from the machine learning model. The predicted combination is used (step 1010) to determine drift between a first data set and a second data set. A corrective action is facilitated (step 1012) in response to the determined drift.

### Drift Monitoring

Referring again to FIG. 1, as the drift identification module 108 is primarily configured to take a static view of the data (e.g., by identifying drift in scoring data at discrete points in time), the drift monitoring module 110 can be configured to monitor (step 142) the scoring data 122 and/or the model predictions 123 over time, for example, to detect systemic changes or trends occurring over consecutive or multiple time periods. In some examples, when drift in a particular feature or set of features from the scoring data is happening frequently or over multiple time periods (e.g., days, weeks, or months), the drift monitoring module 110 can initiate a system effect protocol, which can assess the impact of this drift on the whole of the data. This can be accomplished by building a classifier (e.g., a covariate classifier, also referred to as a covariate shift classifier, a binary classifier, and/or an adversarial classifier) that can discriminate between the training data and the scoring data. If the classifier (or other AI model) can successfully tell the two datasets apart, then this can imply that the drift has had a system-wide effect. Once the impact of the drift has been assessed at both an individual and systemic level, a user of the system 100 can be alerted with a recommended course of action, or other corrective action can be taken or facilitated, as described herein.

As an example, if the user makes predictions with the model 104 every Friday, the drift monitoring module 110 can take each individual feature (or subset of features) in the training data and compare it to a corresponding feature in a new set of scoring data provided on a Friday, so that individual feature data drift can be assessed between two points in time (e.g., between a training data time period and the scoring data time period). If feature drift is identified for a feature on one Friday but then the drift disappears or goes back to normal at the next Friday, then the initial drift can be considered transient drift, for example, due to a national holiday or other event (e.g., Black Friday shopping). If feature drift continues over successive Fridays, however, then a significant change may be happening in the system and further investigation should be carried out. This is when the covariate shift classifier of the drift monitoring module 110 can be triggered to determine if drift is occurring in multiple features for those time periods.

In general, the covariate shift classifier can be used to distinguish between the training data and one or more sets of scoring data, for one or more features in the data. In certain examples, the original training data can be concatenated to the scoring data from specific periods of time where individual feature drift has been identified (e.g., from the drift identification module 108). This can result, for example, in a new dataset having the original training data, which can be labeled “Class 1,” and the scoring data from a time period T, which can be labeled “Class 0.” In various examples, any names or labels can be chosen for the target as long as the training data is allocated to one of the classes and the scoring data is allocated to the other class. The covariate shift classifier may not be used to make predictions on new data but instead may be used as an insight model, for example, to determine if and/or why the training and scoring datasets are different. The scoring data time period T can be a single time period (e.g., one day) or an amalgamation of smaller time periods. For example, if predictions have been made for three days in a row and a feature has drifted each day, the time period T for the covariate shift classifier can be three days. Next, the new dataset can be provided as input to the covariate shift classifier, which can classify the data as belonging to either the original training data or the new scoring data. If the datasets are similar and no systemic data drift has occurred, then the classifier may “fail” at discerning between the training data and the scoring data. If there is a substantial shift in the data (e.g., a score of about 0.80 AUC or area under the curve), however, the classifier can easily distinguish between the training data and the scoring data.

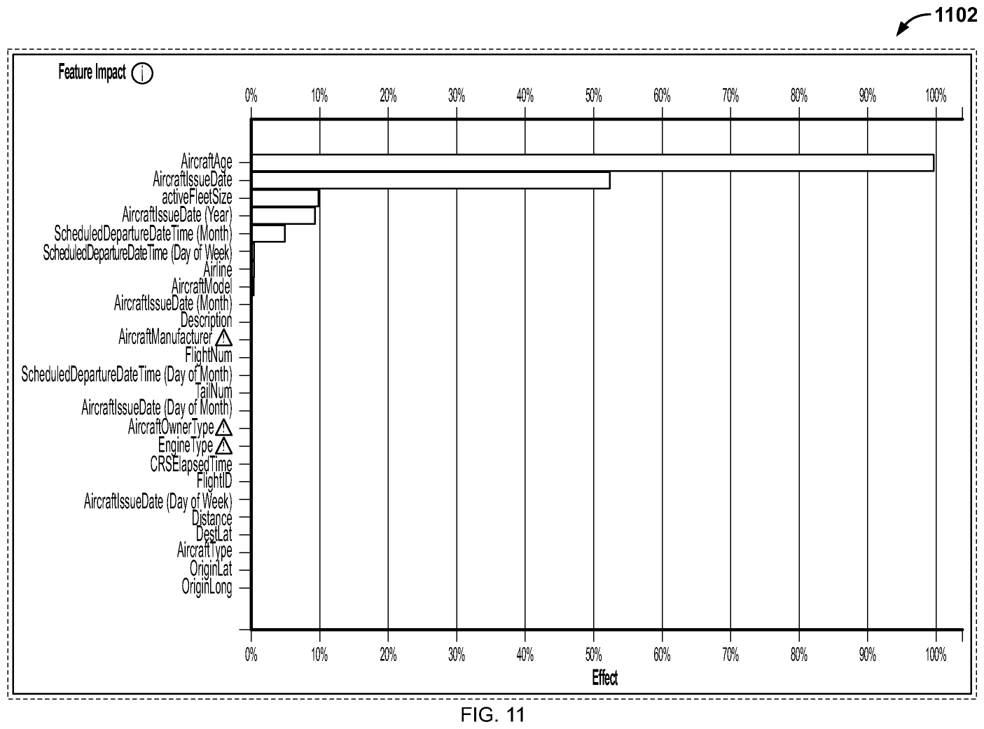

The covariate shift classifier can be run like other binary classification models and, in some instances, insights into multivariate data drift can be derived from feature importance or impact. For example, with this type of model, more important features can be the cause of drift between the training data and the scoring data, while less important features can be stable and/or have no drift between the training data and the scoring data. For example, FIG. 11 includes a screenshot 1102 illustrating an example of running a covariate shift classifier on a dataset over two distinct time periods. The data in this example relates to airlines, and the figure indicates that certain features (e.g., aircraft age) are important for distinguishing the two time periods because these features have drifted. In this example, the model flagged a data “leak” with regard to drift. For example, airlines typically use the same airplanes for several years and each year the planes get older, so even though the system has correctly identified drift in the aircraft age feature, in reality, such drift would be expected. Features having little or no importance, such as aircraft model, can be associated with little or no drift. For example, new aircraft models may be introduced infrequently and therefore the aircraft model feature may be stable over time. Most features in this figure have little or no impact, which means these features have not drifted.

Referring again to FIG. 1, in addition to or instead of monitoring drift in the scoring data (step 142), the drift monitoring module 110 can monitor the model predictions 123 over time (step 144) and, if ground truth data 132 is available, can monitor model accuracy (step 146), for example, by comparing the model predictions 123 with the ground truth data 132. An anomaly detection model can be trained on the training predictions made on the training data 114 and can be used to monitor the scoring predictions being made on the scoring data 122. The anomaly detection model, for example, can be configured to recognize scoring predictions that deviate significantly (e.g., based on a standard deviation) from a majority of the training predictions. Any scoring prediction that deviates or appears abnormal when compared to the training data and/or training predictions can be flagged or shown to the user of the system 100 and/or used to trigger alerts or take corrective action.

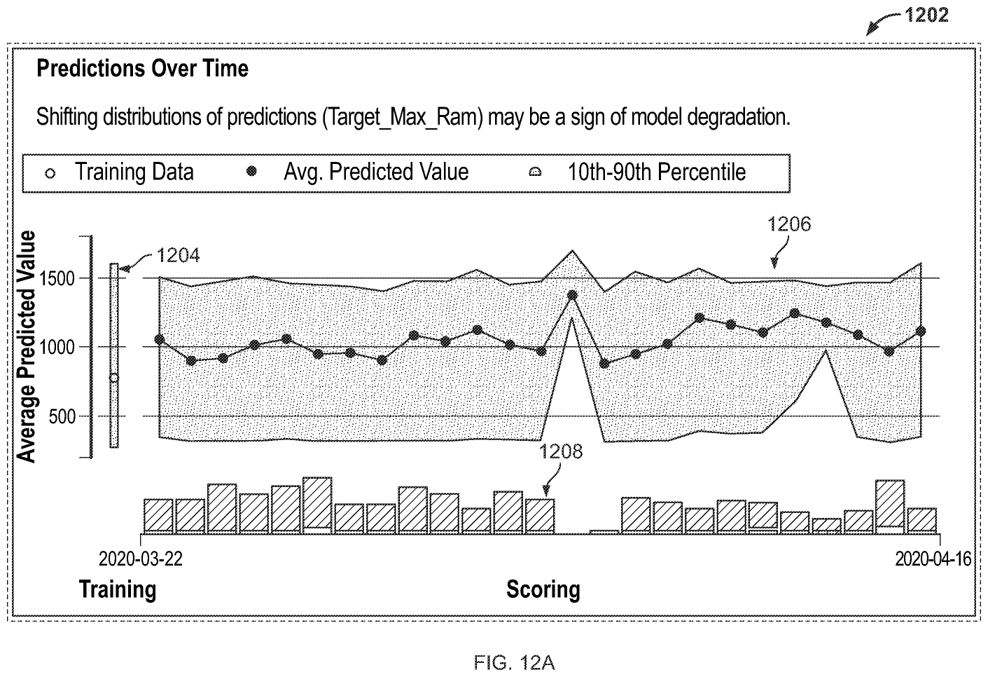

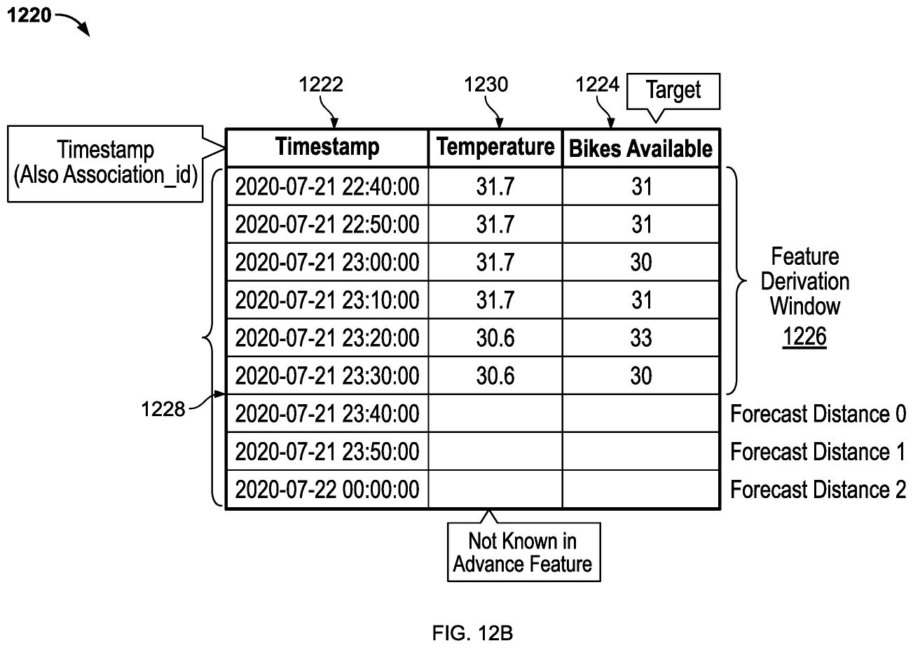

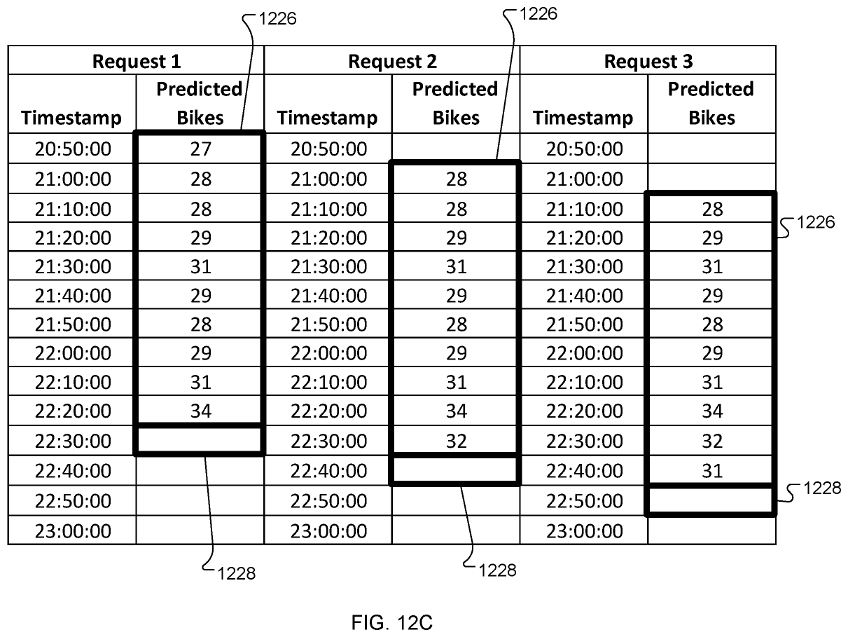

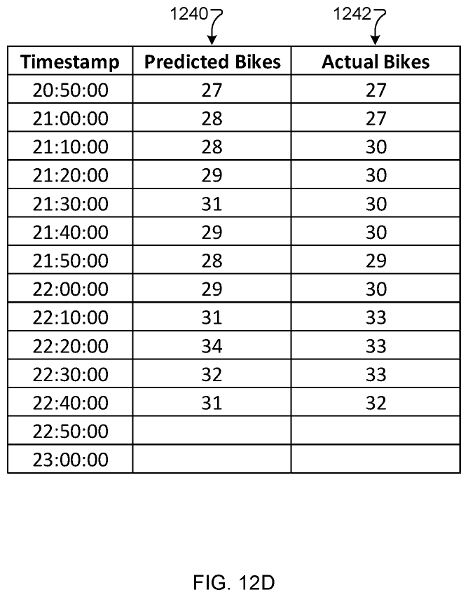

For example, FIG. 12A includes a screenshot 1202 from an example graphical user interface for the systems and methods described herein. The screenshot 1202 includes a bar 1204 indicating an average value and a range of values (e.g., 10th to 90th percentile) for a parameter or feature in the training predictions. The screenshot 1202 also includes a time history 1206 (e.g., with time-series data) of average values and ranges of values, over time, for the parameter or feature in the scoring predictions. A bar chart 1208 is provided below the time history 1206 to indicate a quantity of anomalies for each corresponding point in the time history 1206 of scoring predictions. The bar chart 1208 can include highlighting (e.g., yellow highlighting) to indicate a high quantity of unusual or anomalous predictions. The bar chart 1208 can include bars showing a total number of predictions for various times and/or can indicate a fraction of the predictions that are anomalous (e.g., using the highlighting).

Advantageously, for time series models, the systems and methods described herein can be configured to automatically connect predictions and ground truth results, to ensure model accuracy can be monitored and unexpected drift can be identified. In some examples, the systems and methods can determine an association identifier (association ID) that is used to join predictions with correct actuals. The systems and methods can capture ground truth from time series forecasting requests, compute accuracy metrics, issue alerts (e.g., when model accuracy is poor or unexpected drift is detected), and replay data with one or more challenger models (e.g., to determine if a different model may be more accurate). In certain implementations, a user interface is provided that allows users to enable automatic actuals or ground truth feedback for time series models. The user interface can enable users to implement automatic tracking of attributes for segmented analysis of training data and predictions.

Referring to FIG. 12B, to make ground truth feedback seamless, the systems and methods can exploit a format of a time series forecasting request 1220. The request 1220 can include a timestamp column 1222 which can be used as the association ID for joining predicted values with actual values. A target value column 1224 can include historical observations in a feature derivation window 1226, which includes previous values of the target that can be used to make forecasts. In general, the feature derivation window 1226 can be a period of time before a forecast point 1228 (a time at which a forecast is made) within which features can be derived for the time series. Empty rows in the target value column 1224 correspond to times for which forecasts will be made (e.g., in a forecast window). One or more additional columns 1230 can include values for other features (e.g., temperature) that may or may not be known in advance during prediction requests.

The example in FIG. 12B relates to a model for predicting how many bikes will be available for use at a bike sharing station. Predictions are made every ten minutes (corresponding to the timestamps in the timestamp column 1222) and each prediction represents a predicted number of bikes that will be available 10 minutes into the future. For example, the forecast point 1228 (e.g., a current time) in the example is 23:30:00 and the prediction made at the forecast point 1228 will be for 23:40:00 (forecast distance 0). The next two predictions will be for 23:50:00 (forecast distance 1) and 00:00:00 (forecast distance 2).

When a forecasting request is observed by the system (e.g., in response to a user request), tuples (e.g., timestamp, forecasted_value) can be saved in a database system, for future reconciliation. When a subsequent request occurs, actual values for past predictions may be available as historical values, and corresponding tuples (e.g., timestamp, actual_value) can be extracted. Previously collected tuples for predictions (e.g., timestamp, forecasted_value) can be joined with tuples for actual values (e.g., timestamp, target) using timestamp (or other association ID) as a key. Such data can be used to compute prediction accuracy metrics, such as, for example, root mean square error (RMSE), mean absolute error (MAE), R2, etc.

Referring to FIG. 12C, the predictive model can make predictions using data from the feature derivation window 1226, which can include historical data from a preceding time period, such as a preceding 90-minute window. The historical data can include, for example, an actual number of available bikes, a predicted number of available bikes, weather conditions (e.g., outdoor temperature), date, day of week, time of day, and/or other features that can influence supply and/or demand for bikes. The depicted example shows three consecutive prediction requests, Request 1, Request 2, and Request 3, corresponding to predictions that will be made at 22:20, 22:30, and 22:40, respectively. In each case, the model will use data from the feature derivation window 1226 to predict how many bikes will be available at the forecast point 1228, 10 minutes into the future. For example, Request 1 will be executed at 22:20 to predict the number of bikes that will be available at 22:30 based on data available from 20:50 to 22:20. The timestamps in the example correspond to times when data is available and predictions are made.

As predictions are made and actual values are received, the predictions and actual values can be stored in a database and/or analyzed to determine model accuracy. For example, referring to FIG. 12D, the systems and methods can review previous predictions 1240 and corresponding actual values 1242 to assess model performance. When the model predictions 1240 deviate considerably from the actual values 1242, the systems and methods can determine that unexpected drift has been encountered. For example, the systems and methods can determine that model predictions 1240 have drifted away from actual values 1242 and/or that one or more features have drifted in an unexpected manner. In response, the systems and methods can take corrective action such as, for example, retraining the model with new data, switching to a different model (e.g., a challenger model), and/or sending an alert to a user, as described herein. In general, by combining predictions from one request with ground truth values that are available later (e.g., at a subsequent request), the systems and methods can build a dataset for accuracy estimation and unexpected drift detection that requires little or no direct action from users.

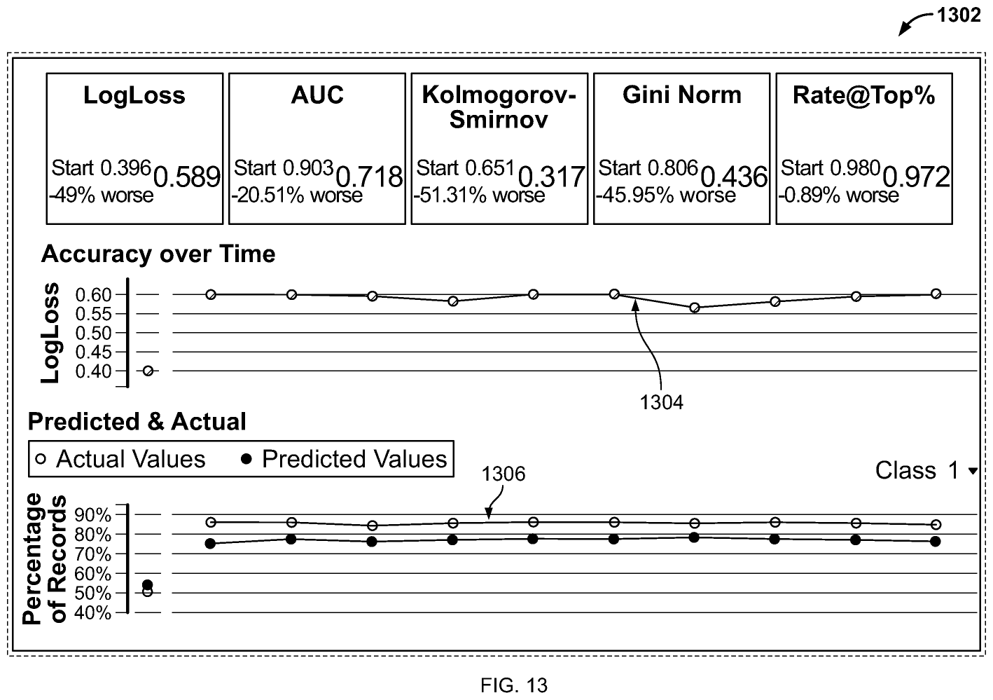

For some use cases, ground truth data (e.g., an actual answer) for a prediction may be known soon after the prediction has been made, or may not be known until several hours, days, weeks, or months later. For example, whether a user will click on a link during a visit to a website can be determined quickly. Alternatively, whether or not a driver will be involved in a car accident under an insurance policy may not be known until the policy is terminated. Advantageously, the systems and methods described herein can allow users to upload ground truth data to the scoring data, so model accuracy can be tracked over time. For example, FIG. 13 includes a screenshot 1302 from an example graphical user interface for monitoring a model's performance over time. The screenshot 1302 includes a time history 1304 of model accuracy and a time history 1306 comparing predicted values versus actual values (ground truth data). Accuracy scores for the model (e.g., Log Loss, AUC, Kolmogorov-Smirnov, and Gini score) are also included in the screenshot 1302.

Referring again to FIG. 1, in various implementations, the drift monitoring module 110 can generate alerts (e.g., using the alert management component 134) when significant drift is detected in the scoring data and/or when model accuracy has deteriorated, over time. Such alerts can be triggered, for example, based on a comparison between the drift (or model accuracy) and one or more predetermined thresholds. In some implementations, the drift monitoring module 110 can send an alert to the user, so that the user can take corrective action to address drift or accuracy issues. Alternatively or additionally, the drift monitoring module 110 can send such alerts to the model management module 112 or other system components, which can take or facilitate appropriate corrective action automatically.

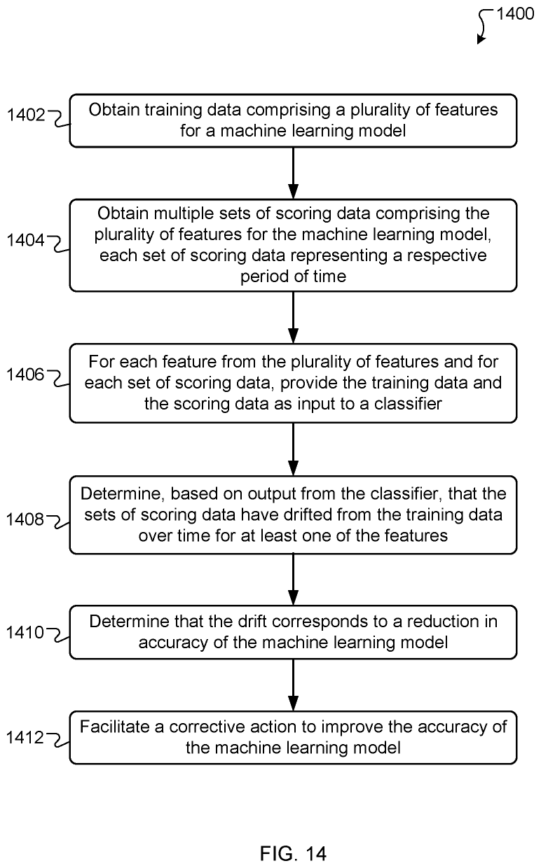

FIG. 14 is a flowchart of a method 1400 of monitoring or managing data drift for a machine learning model. Training data including a plurality of features is obtained (step 1402) for the machine learning model. Multiple sets of scoring data including the plurality of features are obtained (step 1404) for the machine learning model, with each set of scoring data representing a respective period of time. For each feature from the plurality of features and/or for each set of scoring data, the training data and/or the scoring data are provided (step 1406) as input to a classifier. Based on output from the classifier, it is determined (step 1408) that the sets of scoring data have drifted from the training data over time for at least one of the features. It is further determined (step 1410) that the drift corresponds to a reduction in accuracy of the machine learning model. A corrective action is facilitated (step 1412) or taken to improve the accuracy of the machine learning model.

### Model Management

Referring again to FIG. 1, in general, the model management module 112 is configured to perform model governance/approvals, refresh or retrain the model 104, or switch from the model 104 to a different model (e.g., a challenger model), for example, in response to detected drift in scoring data or a reduction in model accuracy. A model refresh or retraining can be performed, for example, when it is determined that the model 104 was trained using training data that is now obsolete or inaccurate, and new or updated training data is available. The challenger model can be used as an alternative to the current model 104. Challenger models can be selected at the deployment stage to run in parallel with the model 104, or can be run only when a drift or model accuracy event is triggered. For example, the model management module 112 can be triggered by the drift identification module 108 and/or the drift monitoring module 110. Alternatively or additionally, the model management module 112 can be called or used independently, without being triggered by the drift identification module 108 or the drift monitoring module 110. The model management module 112 can also implement approval policies as part of a governance framework. Such policies can help ensure that model deployment and replacement is accomplished in a controlled and auditable manner, particularly for models that are or will be deployed in a production environment.

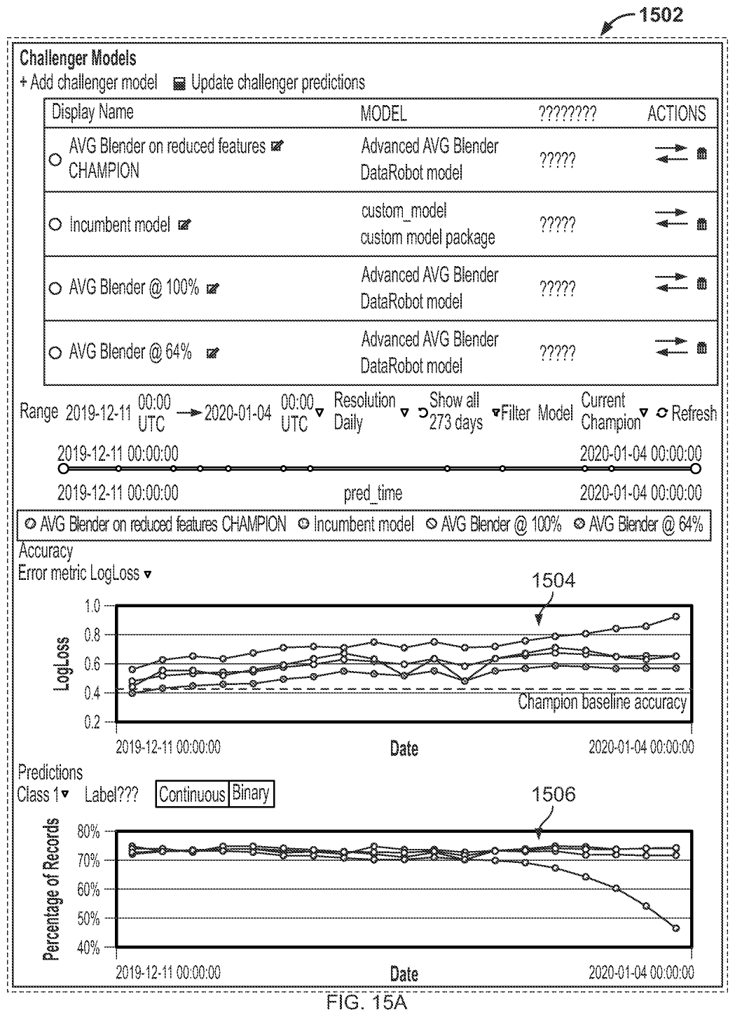

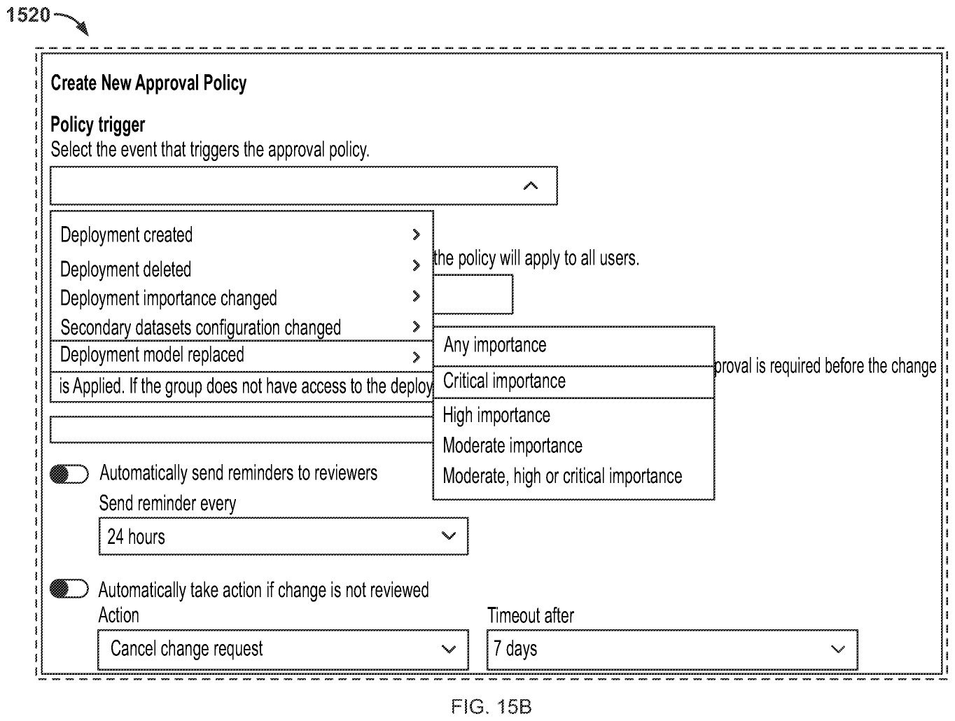

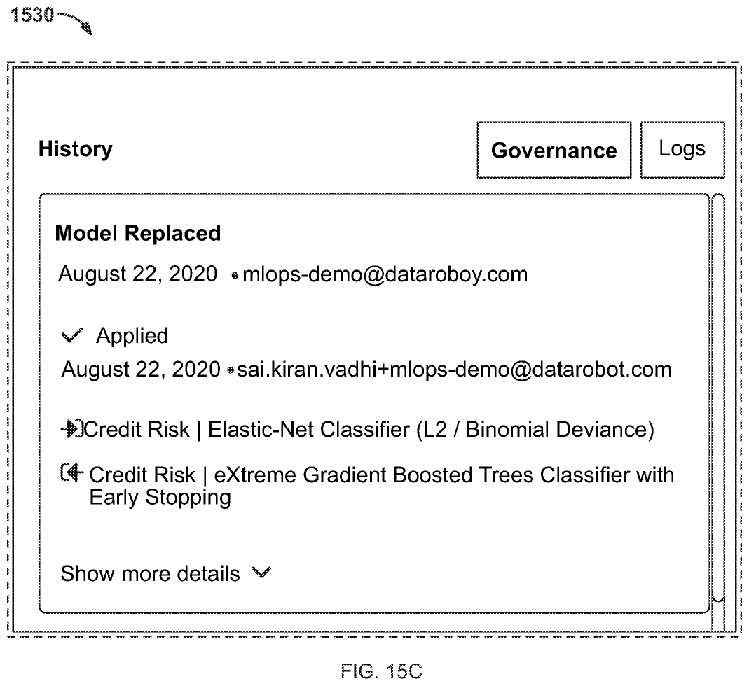

In various implementations, a user of the system 100 can set up multiple models to serve as challenger models for the model 104, so that the user can switch from the model 104 to an alternative, challenger model at any time. Such models can be or include, for example, BESPOKE weather models for sports or sales models for holiday events. For example, FIG. 15A includes a screenshot 1502 from an example graphical user interface for monitoring the performance of a model and a plurality of challenger models over time. The screenshot 1502 includes a time history 1504 of accuracy (e.g., Log Loss) for the models and a time history 1506 comparing predicted values from the models. In general, challenger models can be implemented as alternative models when data drift has been identified or when accuracy of a primary model has degraded over time.

Various strategies may be available for the user when configuring challenger models, for example, to provide flexibility for the model risk management (MRM) standards of the user's organization. One such strategy is referred to as “shadowing” and can involve pairing a primary model that serves all predictions with one or more secondary monitored models that receive or serve the same predictions for validation/comparison. Another strategy is referred to as “A/B/n testing” and can involve testing the primary model and one or more secondary models by weighting prediction traffic to the primary model and the one or more secondary models (e.g., some predictions are assigned to the primary model and other predictions are assigned to secondary models). Another strategy is referred to as “tiered promotion” and can involve facilitating model validation in several lower tiered environments (e.g., development, staging/UAT) before models are promoted to production deployment.

Referring again to FIG. 1, in some instances, a challenger model can be triggered or initiated by the alert management component 134 of the drift monitoring module 110 and/or by the adaptive drift learner 126 of the drift identification module 108. When an alert is triggered, for example, the alert management component 134 and/or the adaptive drift controller 138 can decide (e.g., using artificial intelligence) whether to automatically trigger a challenger, if available, or build a new training set for creating a new model and/or new set of challenger models, based on one or more heuristics or thresholds. While the process can be fully automated, the one or more heuristics or thresholds can be defined by users. This can allow the alert management component 134 and/or the adaptive drift controller 138 to adapt over time, as users provide feedback or adjust or fine-tune the heuristics or thresholds, such that the alert management component 134 and/or the adaptive drift controller 138 can learn better or more appropriate heuristics or thresholds over time. The heuristics can be dependent on data size, number of rows, number of columns, performance of challenger models, drift in the challenger models, and/or a quantity of scoring data 122 that can be matched up with corresponding ground truth data 132. In various instances, when data drift or model inaccuracies have been detected, one or more characteristics related to the training data, scoring data, and/or model performance (e.g., data size, number of rows, number of columns, performance of challenger models, drift in the challenger models, and/or a quantity of scoring data 122 that can be matched up with corresponding ground truth data 132) can be provided as input to the alert management component 134 and/or the adaptive drift controller 138, which can then select an appropriate corrective action. For example, if the performance of the challenger models has degraded along with the performance of the model 104, then it may not be helpful to switch to a challenger model. Additionally or alternatively, if there is no new ground truth data 132 corresponding to the scoring data 122, then it may not be desirable or possible to refresh or retrain the model 104.

In various examples, when the accuracy of the model 104 has been flagged as degrading and there is a sufficient quantity of new ground truth data 132 available, then a new set of training data may be constructed by performing append, reduce, and/or replace operations on the training data. These operations can be performed using the data management component 137, which can choose a suitable (e.g., optimal) data operation based on one or more data characteristics (e.g., a size of the training data and/or the scoring data, an amount of drift in the training data and/or the scoring data, and/or a percentage of anomalies in the training data and/or the scoring data). For example, the data management component 137 can receive the data characteristics as input and provide as output a selected (e.g., optimal) data operation. Alternatively or additionally, the data management component 137 can implement or perform the selected (e.g., optimal) data operation automatically, based on the data characteristics. In some implementations, a user can specify the data operations that will be performed or can define a customized set of retraining requirements. Additionally or alternatively, the user can adjust or customize the data management component 137 to choose data operations preferred by the user.

In some instances, for example, new scoring data can be appended to the original training data to make a new training data set. The append operation may be preferable (and chosen by the data management component 137) when the original dataset is less than a threshold size (e.g., 50,000 rows, where one row can represent an observation or record). There may be a trade-off between dataset size and time or computational power required when using the append operation, given that appending scoring data each time can end up with a very large dataset.

Additionally or alternatively, the reduce operation can be performed to reduce a size of the original training data while retaining the new scoring data. Reducing the original training data can be performed, for example, by selecting and removing a random sample of fixed length from the training data. For example, 20,000 rows, 20% of the rows, a user-defined number of rows, or some other portion of the training data can be randomly selected and removed, and all other training data can be retained. Additionally or alternatively, reducing the original training data set can involve removing all rows that are older than a specified age. For example, all rows corresponding to training data older than 3 months, 6 months, one year, a user-specified age, or other age can be selected and removed from the training data, and all other training data can be retained. Additionally or alternatively, an anomaly detection model (e.g., built on new scoring data) can be used to make anomaly predictions on the original set of training data. The most anomalous rows of the training data can then be identified and removed. In some instances, for example, the quantity of anomalous rows removed can be specified by the user and/or can be 10%, 20%, 50%, or some other portion of the training data. Non-anomalous training rows can then be appended to new scoring data to make the new set of training data.

The model management module 112 can implement an approval policy framework to ensure that model deployment and/or replacement (e.g., driven by challenger models) is accomplished in a controlled and auditable manner. Referring to FIG. 15B, a user interface 1520 is provided that allows users to create new approval policies. This can allow users to configure the model deployment actions that should be governed by an approval workflow. This can allow members of a model risk management group (or other review group) to assess the impact of a model deployment action and then approve, reject, or request changes to the action. Referring to FIG. 15C, for deployment actions governed by an approval policy, an audit history 1530 can be recorded and displayed to show the actions taken and individuals involved (e.g., requesters and/or approvers).

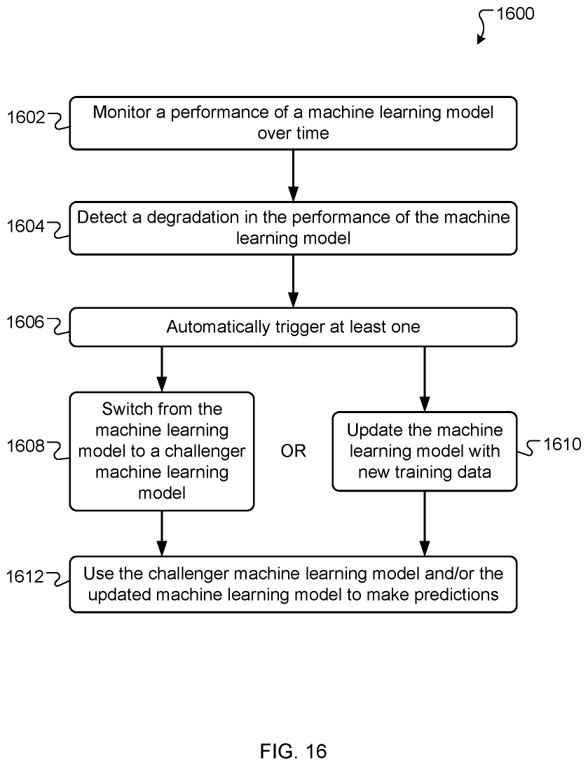

FIG. 16 is a flowchart of a method 1600 of monitoring and managing a machine learning model. A performance of a machine learning model is monitored (step 1602) over time. A degradation in the performance of the machine learning model is detected (step 1604). In response to the detected degradation in the performance, at least one of the following actions is triggered (step 1606): switching (step 1608) from the machine learning model to a challenger machine learning model; or updating (step 1610) the machine learning model with new training data. At least one of the challenger machine learning model or the updated machine learning model is used (step 1612) to make predictions.

### Model Control

Referring again to FIG. 1, in general, the MLOps controller 120 can act as an interface between a prediction environment (e.g., including the model package 102) and an MLOps environment (e.g., including the data aggregation module 106, the drift identification module 108, the drift monitoring module 110, and the model management module 112) for the system 100. The controller 120 can use the monitoring agent 160 and the management agent 162 to manage and monitor model deployments and model predictions in any prediction environment.

In general, a “prediction environment” can be or include a computing environment in which a model is deployed and/or used to make predictions. The prediction environment can be or include, for example, a computing platform (e.g., a web-based or online platform hosted by a third party, such as a company, corporation, or other entity that does not provide or host the MLOps environment) that performs operations associated with deploying, running, or executing a predictive model (e.g., model 104). Such operations can include, for example, providing the model with input data (e.g., scoring data), using the model to make predictions (e.g., the predictions 123), and providing the predictions as output from the model.

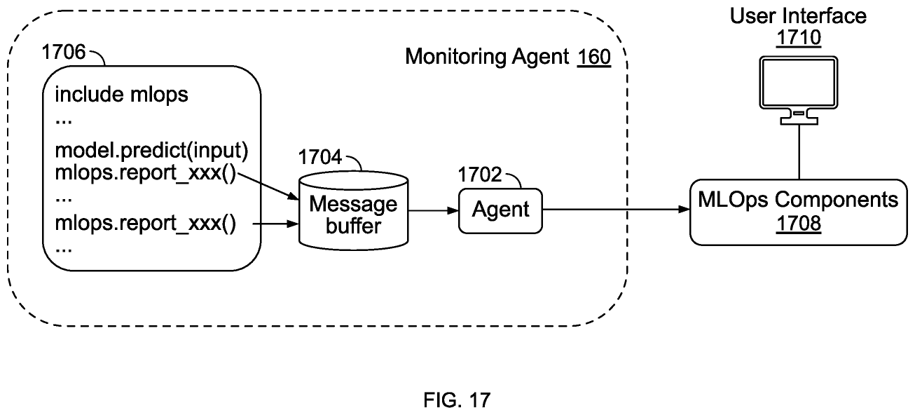

In general, the monitoring agent 160 can allow users to monitor features, prediction results, and prediction accuracy for models running in any prediction environment in near-real time, and the monitoring can be performed without knowledge of the model structure (e.g., schema for model inputs and outputs). Referring to FIG. 17, the monitoring agent 160 can include a monitoring agent service 1702, a message buffer 1704, and an MLOps library 1706. The monitoring agent service 1702 can be responsible for aggregation and transmission of monitoring metrics to MLOps components 1708 (e.g., including the data aggregation module 106, the drift identification module 108, the drift monitoring module 110, and/or the model management module 112). Such metrics can be presented to users on a user interface 1710. In general, the aggregation of monitoring metrics can be implemented to improve monitoring performance in high-scale use cases and/or to reduce network bandwidth requirements. The aggregation can involve, for example, generating a data summary and/or calculating one or more values related to model predictions or model performance, such as an average, a minimum, a maximum, and/or a standard deviation for model predictions or scoring data. The message buffer 1704 (or channel) can facilitate the transmission of metrics between a prediction environment executing model predictions (e.g., an external environment including the model package 102) and the monitoring agent service 1702. The message buffer 1704 can be configurable and/or scalable to meet requirements for real-time or near real-time monitoring and can allow the monitoring agent service 1702 to run in an environment disconnected from the prediction environment. The MLOps library 1706 can provide or utilize application programming interfaces (APIs) to report prediction data or other information from the model (or prediction environment where the model is deployed) to the message buffer 1704. This capability can be supported at scoring time or may be integrated outside of a prediction path entirely.

In a typical example, the monitoring agent 160 can receive model predictions, model features, model performance data, and other model data from a prediction environment. The model data can be ingested and/or processed using the MLOps library 1706 (and associated APIs) and provided to the message buffer 1704. The message buffer 1704 can forward the processed model data to the monitoring agent service 1702 in real time, upon request, or at desired intervals. The monitoring agent service 1702 can aggregate the processed model data, as desired, and forward the processed model data to the MLOps components 1708, which can take action based on the data and/or can display the data for users.

The management agent 162 can provide users with automated and standardized management of models and model prediction environments. The automation can encompass a full model deployment lifecycle and can include capabilities for provisioning and maintaining an associated infrastructure responsible for serving a model (e.g., in a prediction environment). The management agent 162 can accomplish these tasks by translating user actions in other system components and applying the actions to both individual model deployments and related software infrastructure. Actions supported by the management agent 162 can include actions in modeling environments (e.g., where models are developed and trained) and prediction environments (e.g., where models are deployed and run). Such actions can include, for example: deploying models; stopping models; deleting models; replacing models; determining model health status (e.g., model accuracy); executing prediction jobs; determining prediction job status (e.g., job progress or time remaining for a job); determining prediction environment health status (e.g., identifying issues with data drift or prediction drift); starting a prediction environment; and stopping a prediction environment. The management agent 162 can respect but be decoupled from upstream replacement and approval policies implemented by the model management module 112. For example, the management agent 162 may take action only after approvals have been received in accordance with an organization's approval policy.

In various examples, the management agent 162 supports a plugin architecture that decouples a management framework from a mechanism that applies user actions in the prediction environment. This can provide flexibility of usage in any prediction environment, such as, for example, KUBERNETES, DOCKER, AWS LAMBDA, etc. The management agent 162 can utilize a stateless design and reconciliation methodology, which can enable fault tolerance while providing eventual consistency. With the stateless design and reconciliation methodology, for example, the management agent 162 itself may not store a state of either a deployment in an MLOps application environment or a deployment in the prediction environment. When the management agent 162 starts or recovers from an outage, the management agent 162 can inspect both environments and reconcile any changes that should be applied and/or may have occurred during the outage.

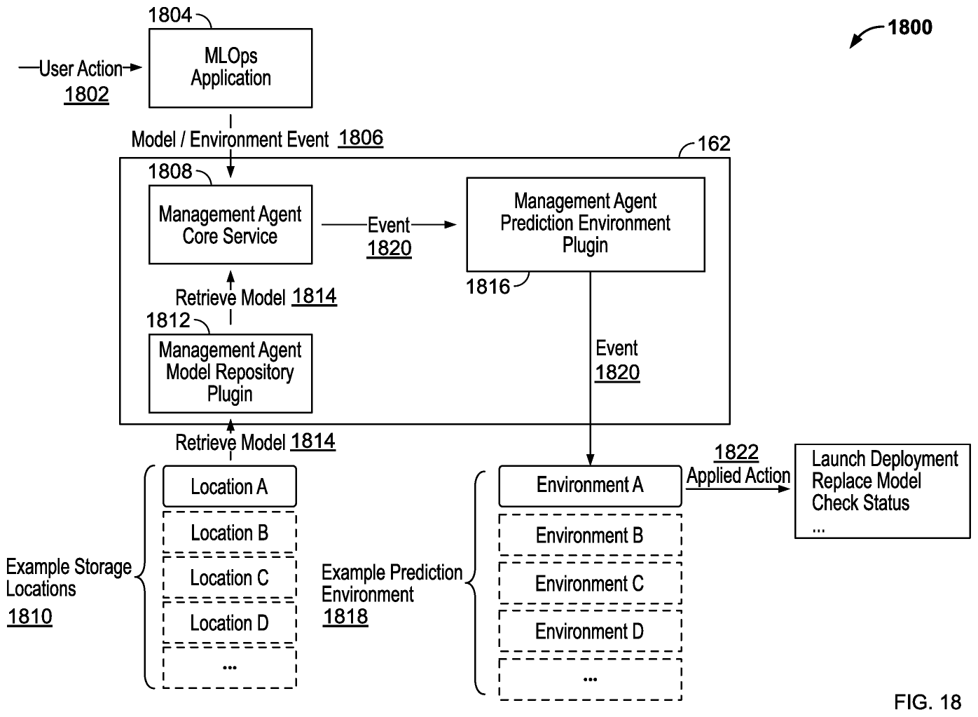

FIG. 18 is a schematic diagram of a method 1800 performed using the management agent 162, in accordance with certain examples. A user action 1802 is provided to an MLOps application 1804 (e.g., including the data aggregation module 106, the drift identification module 108, the drift monitoring module 110, and/or the model management module 112). The user action 1802 can be or include, for example, a request to deploy a model, a request to make predictions using the model, or a request to replace the model with a different model. The MLOps application 1804 (alternatively referred to as an “MLOps component”) processes the user action 1802 and generates a model/environment event 1806, which can be or include a communication from the MLOps application 1804 to implement the user action 1802. Additionally or alternatively, the model/environment event 1806 can be or include a communication or request generated by the MLOps application 1804 for managing data, refreshing a model, controlling data drift, replacing a model with a challenger model, or taking other action. Such communications can be generated by the data aggregation module 106, the drift identification module 108, the drift monitoring module 110, and/or the model management module 112. The model/environment event 1806 can be transmitted from the MLOps application 1804 to a management agent core service 1808 in the management agent 162.

In an example involving model deployment, the model/environment event 1806 can require a model to be retrieved from one or more storage locations 1810, which can utilize or include storage available in the MLOps application 1804, remote storage, a cloud storage service, or a third party storage service or repository, such as, for example, AMAZON S3, GITHUB, or ARTIFACTORY. To enable communications between the management agent core service 1808 and a variety of storage locations 1810, the management agent 162 includes or utilizes one or more model repository plugins 1812. The plugins 1812 can provide flexibility by allowing the management agent core service 1808 to communicate and exchange data with the various storage locations 1810, which can each utilize or include a unique communication protocol and/or data or storage schema. Each of the plugins 1812 can be associated with a respective storage location 1810. The plugins 1812 can be used to retrieve a model 1814 and provide the model 1814 to the management agent core service 1808.

To take an action with respect to a model (e.g., the model 1814), the management agent 162 can include or utilize one or more prediction environment plugins 1816. The plugins 1816 can provide flexibility by allowing the management agent core service 1808 to communicate and exchange data with various prediction environments 1818. In some examples, the prediction environments 1818 can be or include one or more computing platforms (e.g., hosted by third parties) that perform operations associated with deploying, running, or executing predictive models. Examples of such computing platforms can include KUBERNETES (EKS), KUBERNETES (GKE), AWS LAMBDA, and DOCKER. Each of the plugins 1816 can be associated with a respective prediction environment 1818. In the depicted example, the plugins 1816 receive an event 1820 from the management agent core service 1808, which can generate the event 1820 in response to the model/environment event 1806. When the model/environment event 1806 includes a request to deploy a model, for example, the event 1820 can include or correspond to a model deployment request. One of the plugins 1816 can the forward the event 1820 to a respective prediction environment 1818, which can take an action 1822 in response to the event 1820. The action 1822 can be or include, for example, launching a model deployment, replacing a model with a different model, checking the status of the model, running a prediction job, or any other action performed in the prediction environment 1818 with respect to the model.

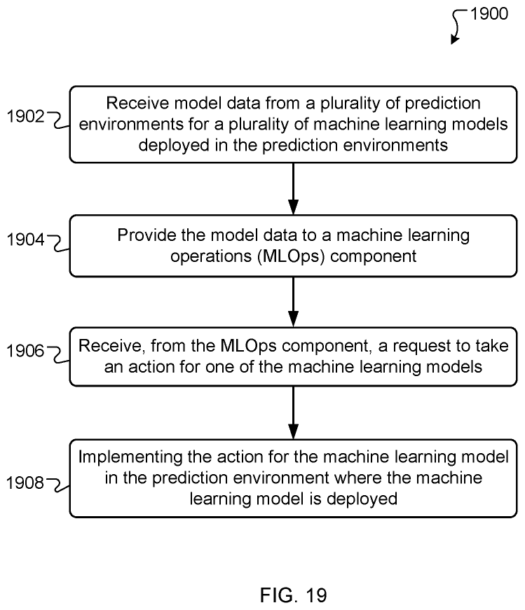

FIG. 19 is a flowchart of a method 1900 of controlling machine learning operations. Model data is received (step 1902) from a plurality of prediction environments for a plurality of machine learning models deployed in the prediction environments. The model data can include model predictions and/or can be received using the monitoring agent 160. The model data is provided (step 1904) to a machine learning operations (MLOps) component configured to perform operations including: aggregating a stream of scoring data, identifying drift in scoring data or model predictions, generating alerts related to the drift, and/or generating requests related to model adjustment or replacement. A request to take an action for one of the machine learning models is received (step 1906) from the MLOps component (e.g., received by the management agent 162). The action for the machine learning model is implemented (step 1908) in a respective prediction environment wherein the machine learning model is deployed.

### Example Use Cases

In various examples, the systems and methods described herein can be used to achieve centralized deployment, management, and/or control of an organization's statistical, rule-based, and predictive models, independent of the underlying modeling platform. The systems and methods can use a set of interrelated components (e.g., the data aggregation module 106, the drift identification module 108, the drift monitoring module 110, the model management module 112, and any portions thereof) that can be mixed and matched, depending on business requirements. For example, a company that updates models frequently may be more interested in model management than in data management, whereas a company whose models are regulated by external governance may be focused on data management and/or data drift identification. The modular nature of the systems and methods enables plug-and-play capabilities to support diverse business challenges associated with models. Techniques for real-time web analytics can be adapted to provide efficient metrics for monitoring model accuracy, model health (e.g., number of scoring rows being rejected), and data drift (changes in the data over time).

It is estimated that 61% of businesses implemented artificial intelligence (AI) in 2017, and 71% of executives surveyed said their company has an innovation strategy to push investments in new technologies, such as automated machine learning (AutoML). For late adopters of AI and AutoML, there are several technological options to investigate, but for early adopters there may be an innovation gap. Such companies can have predictive analytic models integrated into their current systems and may have teams of data scientists available, but the companies may want to isolate the deployment, management, and performance monitoring of their models. Companies that were early adopters may now understand issues involved with taking a machine learning model and translating the model's value into terms of dollars and/or customer metrics, such as booking cancellations.

Post-modeling can be considered part of operations rather than a responsibility of data scientists, which can free up the data scientists to focus on developing new models and projects. This split may be somewhat analogous to a difference between software development and IT operations, where software engineers are freed from the responsibility of system maintenance. Data science platforms have also recognized the difficulty in deploying machine learning models to production, as well as identifying the distinction between a data scientist and an operations software engineer.

In addition to a post-modeling innovation gap, there may also be a problem of infrastructure. For example, as differing parts of an organization adopted AI at different speeds, models were implemented using chosen tools of the data scientists or implemented in legacy software, such as SAS, because of licensing restrictions. Thus, centralizing post-modeling and making predictive analytics a part of everyday business operations requires a technological solution that can seamlessly integrate multiple models from disparate platforms and from multiple business divisions. Advantageously, the systems and methods described herein can provide this technological solution.

A machine learning model should be seen as any other organizational asset. The model can have a distinct product lifecycle and/or can degrade over time in response to environmental factors, such as economic conditions, competitors, and/or changes in customer behavior. A key aspect of model lifecycle management can be to monitor and manage both the machine learning model and the data the model uses to make predictions. The systems and methods described herein provide a technological solution capable of identifying any changes (drift) in the data, evaluating the impact this drift may have on the performance of the model, and taking appropriate action by adapting the model to this new environment. Data drift can erode data fidelity, operational reliability, and ultimately productivity, and it can increase costs and lead to poor decision-making by data scientists.

There are several business problems and challenges that the systems and methods described herein are able to solve. The diversity of these challenges can illustrate the innovation gap in both post-modeling operations and in technological solutions available to businesses. In one example involving information technology and operations, a large, multinational company may want to centralize its machine learning operations, including centralized cloud management and control. The company may need a technological innovation capable of deploying models, along with the company's containerized runtime environment, in a seamless way that allows data scientists to use tools of their choice while sharing the same underlying infrastructure that allows deployment of models at scale. Advantageously, the systems and methods described herein can be used by the company to provide automated monitoring of the performance of machine learning models from both a cloud usage and data science perspective. The company can have business models that may generate billions of predictions every day, resulting in a massive volume of data. The systems and methods can accurately record statistics about all of these predictions in a format that is both efficient to store and fast to query. Additionally or alternatively, the company may have an internal predictive model that predicts an amount of memory a job will take before being allocated cloud resources, such as containers. The actual memory used by the job may be available when the job has been completed. With the centralization of machine learning operations, the systems and methods can achieve a more diverse set of users, use cases, datasets, and models over time. The systems and methods can automatically adapt and refresh the company's job resource model in response to changing environments, without the need of a data scientist. Such information technology and operations use cases may be focused on or receive significant benefit from the MLOps controller 120, which can act as an interface between models, users, and the cloud.

In another example, related to sports and gaming, an online sports data company may have a technological need for predictive models that are integrated into the company's real-time sports data streaming and/or fantasy sports picks. The systems and methods described herein can provide an IT operations solution where multiple models from multiple sources can be deployed together and a post-modeling solution where the models can be updated and retrained when data drift has occurred. The systems and methods can provide a short-forecast solution that can make real-time in-play predictions from streaming data and adapt the model in-play, as needed. Additionally or alternatively, the systems and methods can include a long-forecast solution (e.g., for tournaments and leagues) when an automatic model refresh may be triggered after data drift has been identified. The systems and methods can run the short-forecast and long-forecast models in parallel (e.g., as champion models and challengers) and can predict on real-time streaming data. The systems and methods can allow the company to seamlessly switch between the models during sporting events, for example, when using BESPOKE models fine-tuned to weather conditions for each sporting event. In general, the short-term model which refreshes regularly may rely on the data aggregation module 106 and/or the model management module 112. The long-term model may rely on the data aggregation module 106, the drift identification module 108, the drift monitoring module 110, and/or the model management module 112. The company's ability to switch models can be achieved using the model management module 112 at deployment time, with multiple models being run in parallel.

In another example, involving finance and banking, a financial institution may have several machine learning models in production. The models may range from low-risk, unregulated models, such as marketing models, to high-risk, regulated models that contain personal financial information and are heavily regulated by external governance bodies. In such instances, any changes in data may need to be identified early to ensure the model adheres to strict constraints. The systems and methods described herein can provide the institution with both (i) a deployed model alert system that notifies a risk analysts of any fluctuations in scoring data and (ii) an AB testing capability where the institution can run an old model and a replacement model together for a specified period of time. The financial institution may utilize the data aggregation module 106, the drift identification module 108, the drift monitoring module 110, and/or the model management module 112 to achieve such capabilities.

In another example, a leading manufacturer of farming equipment may have several suppliers of parts that make up the manufacturer's machinery, and each part may need its own warranty related to an overall parent product warranty. In such a case, the manufacturer may have been having problems with data quality where some suppliers used the wrong measurement units (imperial not metric) and others failed to supply all relevant information needed to predict an overall product warranty cost. Advantageously, the systems and methods described herein can be used by the manufacturer to identify parts associated with data quality issues and reject or revise such data before it reaches the warranty model. For example, the manufacturer can utilize the data aggregation module 106 and the drift identification module 108 to identify any missing or incorrect data and reject corresponding rows or observations.

In some implementations, use of the data aggregation module 106 can avoid catastrophic system failures caused by processing or storing data being delivered in a data stream, for example, at a rate of a million predictions per hour (or more) and continuing over long periods of time (e.g., one day, one week, one month, one year, or more). Advantageously, the systems and methods described herein can provide an innovative solution to achieve an efficient computation of metrics on a stream of numeric data of unknown size. Organizations that monitor model performance and data drift in real-time applications can have a need for such a capability.

### Computer-Based Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

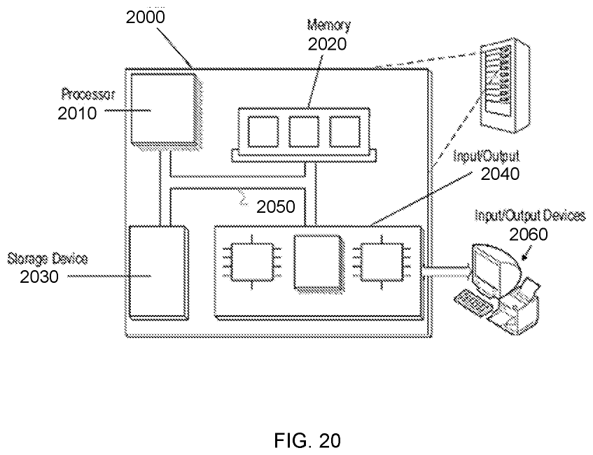

FIG. 20 is a block diagram of an example computer system 2000 that may be used in implementing the technology described herein. General-purpose computers, network appliances, mobile devices, or other electronic systems may also include at least portions of the system 2000. The system 2000 includes a processor 2010, a memory 2020, a storage device 2030, and an input/output device 2040. Each of the components 2010, 2020, 2030, and 2040 may be interconnected, for example, using a system bus 2050. The processor 2010 is capable of processing instructions for execution within the system 2000. In some implementations, the processor 2010 is a single-threaded processor. In some implementations, the processor 2010 is a multi-threaded processor. The processor 2010 is capable of processing instructions stored in the memory 2020 or on the storage device 2030.

The memory 2020 stores information within the system 2000. In some implementations, the memory 2020 is a non-transitory computer-readable medium. In some implementations, the memory 2020 is a volatile memory unit. In some implementations, the memory 2020 is a nonvolatile memory unit.

The storage device 2030 is capable of providing mass storage for the system 2000. In some implementations, the storage device 2030 is a non-transitory computer-readable medium. In various different implementations, the storage device 2030 may include, for example, a hard disk device, an optical disk device, a solid-state drive, a flash drive, or some other large capacity storage device. For example, the storage device may store long-term data (e.g., database data, file system data, etc.). The input/output device 2040 provides input/output operations for the system 2000. In some implementations, the input/output device 2040 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 2060. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 2030 may be implemented in a distributed way over a network, such as a server farm or a set of widely distributed servers, or may be implemented in a single computing device.

Although an example processing system has been described in FIG. 20, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A computer-implemented method comprising:
monitoring a performance of a machine learning model over time;
detecting a degradation in the performance of the machine learning model;
in response to the detected degradation in the performance, automatically triggering at least one of:
switching from the machine learning model to a challenger machine learning model; or
updating the machine learning model with new training data; and
using at least one of the challenger machine learning model or the updated machine learning model to make predictions.

2. The method of claim 1, wherein monitoring the performance of the machine learning model comprises comparing model predictions with ground truth data over time.

3. The method of claim 1, wherein monitoring the performance of the machine learning model comprises detecting a drift in scoring data used to make model predictions.

4. The method of claim 1, wherein monitoring a performance of the machine learning model comprises displaying on a graphical user interface a chart comprising an indication of an accuracy of the machine learning model and an accuracy of the challenger machine learning model over time.

5. The method of claim 1, wherein the degradation comprises a reduction in agreement between model predictions and ground truth data.

6. The method of claim 1, wherein the automatic triggering is based on one or more characteristics comprising a size of a data set, a number of rows in the data set, a number of columns in the data set, a historical performance of the challenger machine learning model, a detected drift associated with the challenger machine learning model, a quantity of scoring data that can be matched up with ground truth data, or any combination thereof.

7. The method of claim 6, wherein the data set comprises training data, scoring data, or a combination thereof.

8. The method of claim 1, wherein switching from the machine learning model to the challenger machine learning model comprises selecting the challenger machine learning model from a plurality of challenger machine learning models based on a historical performance of the challenger machine learning model.

9. The method of claim 1, wherein updating the machine learning model with new training data comprises generating an updated set of training data by combining the new training data with previous training data, reducing an amount of previous training data to accommodate the new training data, replacing previous training data with the new training data, or any combination thereof.

10. The method of claim 1, wherein updating the machine learning model with new training data comprises reducing an amount of previous training data to accommodate the new training data, and wherein reducing the amount of previous data comprises removing a random portion of the previous training data, removing an outdated portion of the previous training data, removing an anomalous portion of the previous training data, or any combination thereof.

11. A computer-implemented method comprising:
receiving model data from a plurality of prediction environments for a plurality of machine learning models deployed in the prediction environments, the model data comprising model predictions;
providing the model data to a machine learning operations (MLOps) component configured to perform operations comprising at least one of: aggregating a stream of scoring data, identifying drift in scoring data or model predictions, generating alerts related to the drift, or generating requests related to model adjustment or replacement;
receiving, from the MLOps component, a request to take an action for a machine learning model from the plurality of machine learning models, wherein the machine learning model is deployed in a respective prediction environment from the plurality of prediction environments; and
implementing the action for the machine learning model in the respective prediction environment.

12. A computer-implemented method comprising:
providing a machine learning model configured to predict a preferred combination of a binning strategy and a drift metric for determining data drift;
determining one or more data characteristics for at least one data set;
providing the one or more characteristics as input to the machine learning model;
receiving as output from the machine learning model an identification of the preferred combination of the binning strategy and the drift metric for the at least one data set;
using the predicted combination to determine drift between a first data set and a second data set; and
facilitating a corrective action in response to the determined drift.

13. A computer-implemented method of processing data comprising:
(a) providing a histogram for a stream of data comprising numerical values, the histogram comprising:
a centroid vector comprising elements for storing centroid values; and
a count vector comprising elements for storing count values corresponding to the centroid values;
(b) receiving a next numerical value for the stream of data;
(c) identifying two adjacent elements in the centroid vector having centroid values less than and greater than the next numerical value;
(d) inserting a first new element between the two adjacent elements in the centroid vector;
(e) inserting a second new element between corresponding adjacent elements in the count vector;
(f) storing the next numerical value in the first new element in the centroid vector;
(g) setting a count value in the second new element in the count vector to be equal to one;
(h) identifying two neighboring elements in the centroid vector having a smallest difference in centroid values;
(i) merging the two neighboring elements in the centroid vector into a single element comprising a weighted average of the centroid values from the two neighboring elements;
(j) merging two corresponding neighboring elements in the count vector into a single element comprising a sum of the count values from the two corresponding neighboring elements; and
(k) repeating steps (b) through (j) for additional next numerical values for the stream of data.
